(19) United States
(12) Patent Application Publication
(10) Pub. No.: US 2018/0172835 A1
(43) Pub. Date: Jun. 21, 2018

(54) SYSTEM AND METHOD FOR PROVIDING A USER WITH AN INDICATION OF POSITION

(71) Applicant: Elite Positioning Technologies Pty Limited, Camberwell (AU)

(72) Inventors: Fergus Koochew, Camberwell (AU); James Callahan, North Carlton (AU)

(21) Appl. No.: 15/738,528

(22) PCT Filed: Jun. 22, 2016
(86) PCT No.: PCT/AU2016/050527

§ 371 Date: Dec. 20, 2017

(30) Foreign Application Priority Data
Jun. 22, 2015 (AU) 2015902400

(51) Int. Cl. G01S 19/19; G01S 19/51; G01S 5/00; G01S 5/02; G07C 1/22

(52) U.S. Cl. CPC G01S 19/19; G01S 19/51; G07C 1/22; G01S 5/0284; G01S 5/0018

(57) ABSTRACT

A system for providing to a plurality of users in a group of users, participating in a community running race along a predetermined path, with an indication of respective positions of the users relative to one or more of the other users. System includes a database for containing location data for the users; a processing station for accessing the database and being responsive selectively to data for generating first signals that are transmitted from a plurality of base stations physically spaced apart along the path; a plurality of wearable devices worn by respective users, the devices including a receiver for receiving first signals, a processor for processing first signals to generate a second signal, and an interface that is responsive to the second signal for visually displaying to the respective user the indication of the position relative to one or more of the other users in the group.

### FIELD OF THE INVENTION

The present invention relates to a system and method for providing to a plurality of users in a group of users with an indication of respective positions of the users relative to one or more of the other users in the group.

Embodiments of the invention have been particularly developed for providing participants in a running event with a real time indication of their ranking relative to other participants and some embodiments will be described herein with particular reference to that application. However, it will be appreciated that the invention is not limited to such a field of use, and is applicable to other events such as triathlons, cycling events and the like, and for providing other parties, such as an organiser of the event, members of the media, spectators and other parties with an indication of the position of the participants relative to each other.

### BACKGROUND

Any discussion of the background art throughout the specification should in no way be considered an admission that such art is widely known or forms part of common general knowledge in the field.

There are many running events held around the world involving large numbers of participants. The larger events of this type include tens of thousands of participants. The popularity of these events, and the enthusiastic involvement of the public, has led to the development of many different timing technologies to provide greater and more accurate feedback to the participants of the time taken to cover the path or course set for the event.

One available technology for providing timing information to participants in such events is radio frequency identification (RFID) timing technologies. These technologies typically provide start and finish timing services, and a split time, to race events such as running events, triathlons, cycling events, multisport events, skiing time trials, horse racing and motorsport. These systems, when used for individual athletes, include a timing chip (either passive or active) that is worn or otherwise carried by each athlete. These chips are able to be interrogated by a transmitted interrogation signal and, when that occurs, the chips initiate a wireless broadcast of a unique code. The interrogation signal is radiated by an antenna that is usually placed within a mat on ground or overhead in an arch. The use of these antennas and mats at the start and finish line allow for the logging of the unique codes from the chips and, together with a timestamp, allow for the determination of the time taken for the individual athletes to complete the course. This functionality also relies upon the use of RFID readers which store the logged data, and software which rationalises the data into results for distribution and publishing.

These RFID timing technologies for athletic events have their origins in motorsport timing from the 1980's which made use of large active transponders with onboard batteries. This form of active transponder is too expensive, and typically too bulky, to implement effectively for individual athletes. In an attempt to apply the RFID timing technologies to provide timing information for running events more recent use has been made of passive transponder technology and ultra high frequency (UHF) disposable chip technology. This technology has been adapted from the logistics and asset tracking industries and typically provides a lower cost solution. This technology has predominantly superseded the use of the earlier RFID systems for mass participation events. Even so, the use of disposable passive chip technology still encounters operational problems and provides very little timing information.

With the proliferation of GPS (and similar) tracking technologies there have been some attempts made to apply these technologies to race events to gain more timing information. The rate of take-up of this solution is limited due in most part to the associated cost as it involves placing a GPS device on each athlete. Such a GPS device periodically transmits a location signal via a mobile data network such as a 3G or 4G network. However, the technology and logistics involved in deploying the GPS device make this solution suitable only to individual use, and expensive to implement on a larger scale. These factors explain the present low rate of usage of such technology for large events.

Some attempts have been made to leverage from the existing GPS device that is included in many smartphones and other handheld electronic devices. For example, a number of smartphone apps offer real-time location tracking using GPS and mobile data networks to allow followers to monitor athletes. However, this requires the athletes to carry their individual smartphones during competition, which is an impractical and unattractive prospect for runners, unworkable for swimmers and triathletes, and inconvenient for other athletes such as cyclists. In addition to the heightened risk of damage to the relatively expensive hardware this technological solution typically provides information only to the athlete.

In addition to those technical solutions applied to mass events, there are also other devices available such as GPS smart sports watches that enable an athlete to track his or her speed, ascent/descent, altitude and time whilst running, cycling and the like. However, these watches rely upon input from the runner about the timing of the start and finish of the event, which is not easily verified or authenticated, and not suitable for operating in contested events and even less so in a large public event.

In more recent times there has been some use of GPS smart sports watches in combination with smart phones. This requires the athlete to wear the watch and carry the smart phone to gain access to the functionality delivered.

There also exist large sophisticated, and correspondingly expensive, defence force GPS technologies. These typically involve the use of real time GPS tracking to support the movement of troops, and providing real time feedback to the troops on their location. This technology, however, is physically too large (cumbersome, heavy and complicated) for deployment in a sports setting, and also far too expensive to be considered outside military or specialist services uses.

In other fields use is also made of timing technologies. For example, in motorsport timing systems typically share the same basic system architecture as that used for athletic events. However, such systems are very accurate—far beyond what is required for a large scale athletic event—and have car mounted components that are heavy and impractical for carrying by an individual athlete. Moreover, such systems are designed for use by a relatively small numbers of competitors in a given event and cannot be easily or cost-effectively scaled up for use in events having large numbers of individual athletes.

Accordingly, there is a need in the art for an improved system and method for providing a user with timing data indicative of one or more characteristics of the user's progression along a predetermined path.

### SUMMARY OF THE INVENTION

It is an object of the present invention to overcome or ameliorate at least one of the disadvantages of the prior art, or to provide a useful alternative.

According to a first aspect of the invention there is provided a system for providing to a plurality of users in a group of users with an indication of respective positions of the users relative to one or more of the other users in the group, the system including:

a first database for containing location data for the users;

a processing station for accessing the first database and being responsive selectively to the location data for generating first signals; and

a plurality of wearable devices for wearing by the respective users in the group, the wearable devices each including:
(a) a receiver for receiving the first signal;
(b) a processor for processing the first signal to generate a second signal; and
(c) an interface that is responsive to the second signal for visually displaying to the respective user the indication of the position of the user relative to one or more of the other users in the group.

In an embodiment at least one of the processing stations and the first database are at least partially cloud-based.

In an embodiment the users are simultaneously progressing along a predetermined path having a start and an end and the indication of the respective positions of the users relative to one or more of the other users in the group is a substantially real time indication of one or more of:
a ranking of the respective users relative to one or more of the other users in terms of progress along the path;
an indication of the time interval along the path between the respective users and one or more of the other users;
an indication of the distance along the path between the respective users and one or more of the other users;
an indication of the distance between the respective users and one or more of the start and the end;
an indication of the respective time of arrival of the users at the end;
a rate of progress of the respective users relative to the rate of progress of any one or more of the other users; and
a required rate of progress of the respective users relative to the rate of progress of any one or more of the other users.

In an embodiment, the indication of the respective positions of the users relative to one or more of the other users occurs continuously in real time.

In an embodiment, the indication of the respective positions of the users relative to one or more of the other users occurs continuously in real time as the user progresses along the path between the start and the end.

In an embodiment, the indication of the respective positions of the users relative to one or more of the other users occurs periodically in real time as the user progresses along the path between the start and the end.

In an embodiment, the indication of the respective positions of the users relative to one or more of the other users occurs intermittently in real time as the user progresses along the path between the start and the end.

In an embodiment, the indication of the respective positions of the users relative to one or more of the other users occurs in real time at a plurality of points spaced apart along the path between the start and the end.

In an embodiment the processing station includes a plurality of spaced apart base stations for wirelessly transmitting the first signals and for receiving wirelessly third signals from the wearable devices.

In an embodiment, the base stations have predetermined locations and the processor is responsive to those predetermined locations for generating the third signals.

In an embodiment the wearable devices each include a location device for providing current location data for the respective devices and the processor is responsive to the current location data for generating the third signals.

In an embodiment the receivers are transceivers and transmit the third signals.

In an embodiment the processing station is responsive to the third signal for updating the location data.

In an embodiment the location devices derive the current location data from one or more of:
one or more GPS signals;
triangulation; and
multilateration.

In an embodiment, in use, the users are progressing along a predetermined path having a start, an end, and at least one waypoint between the start and the end, and the first database contains location data for the waypoints.

In an embodiment, the processor is also selectively responsive to the location data for the waypoints when generating the first signal.

In an embodiment, the system includes an interface for allowing connection with external devices for allowing those external devices to selectively access the location data or event data derived from the location data.

In an embodiment, each wearable device includes a single housing for the receiver, the processor and the interface.

In an embodiment, each wearable device includes a fastening system for allowing releasable fastening of the housing to the respective users.

In an embodiment, the processing station is remote from the users and the first signal is a wireless signal.

According to a second aspect of the invention there is provided a system for providing to a user an indication of a position of the user relative to one or more members in a group of members, the system including:

a first database for containing location data for the group of members;

a processing station for accessing the first database and being responsive selectively to the location data for generating a first signal; and

a wearable device for wearing by the user, the wearable device including:
(a) a receiver for receiving the first signal;
(b) a processor for processing the first signal to generate a second signal; and
(c) an interface that is responsive to the second signal for visually displaying to the user the indication of the position of the user relative to one or more members of the group of members.

In an embodiment the wearable device includes a transmitter for transmitting a third signal and the processor generates the third signal in response to location data indicative of the location of the user.

In an embodiment the processing station is responsive to the third signal for generating the first signal.

In an embodiment the user is one of the members of the group of members.

In an embodiment the user is moving along a predetermined path and at least one of the members is simultaneously moving along the path.

In an embodiment the indication of the position of the user relative to the one or more members of the group includes a positional ranking of the user relative to the one or more members.

In an embodiment the position ranking is in order of progress along the path.

In an embodiment the system includes a plurality of further like wearable devices for wearing by the respective members, wherein each member is provided with respective indications of the position relative to the user.

In an embodiment each member is provided with respective indications of the position relative to at least one other member.

In an embodiment each member is provided with respective indications of the position relative to all other members.

In an embodiment the user is moving along a predetermined path and at least one of the members has previously moved along the path.

In an embodiment the system includes a plurality of further like wearable devices for wearing by the respective one or more members of the group of members, wherein the position data is derived from the third signals.

In an embodiment the location data includes a timestamp.

In an embodiment the or each wearable device includes a location device for generating the location data.

In an embodiment the location device is a GPS module.

In an embodiment the location data is indicative of points on the path for the members of the group.

In an embodiment the predetermined path includes a start and an end and the indication of the position of the user relative to one or more members of the group of members is one or more of:

an indication of the positional ranking of the user relative to the one or more members of the group;

an indication of the physical spacing between the user and one or more members of the group; and

an indication of the time spacing between the user and one or more of the members of the group.

In an embodiment the system includes a base station for transmitting the first signal.

In an embodiment the system includes a plurality of spaced apart base stations for transmitting the first signal.

In an embodiment the or each base station receives the third signal and communicates it to the processing station.

In an embodiment the processing station generates related party data that is stored in a second database and the system includes a user interface for allowing one or more third parties to selectively access the related party data.

In an embodiment the third parties include one or more of an administrator for the system, an organiser of an event in which the user is participating, a spectator of the event, and a media organization.

According to a third aspect of the invention there is provided a wearable device for providing to a user an indication of a position of the user relative to one or more members in a group of members, the device including:

a fastening system for fastening the device to the user;

a receiver for wirelessly receiving a first signal from a processing station, the first signal being derived from location data for one or more of the members;

a processor for processing the first signal to generate a second signal; and an interface that is responsive to the second signal for visually displaying to the user the indication of the position of the user relative to one or more members of the group of members.

According to a fourth aspect of the invention there is provided a wireless base station for a system for providing to a user an indication of a position of the user relative to one or more members in a group of members, the base station including:

an interface for receiving a first signal from a processing station and for providing a second signal to the processing station, the first signal being derived from location data for the group of members;

a transmitter for wirelessly transmitting the first signal to a wearable device for wearing by the user; and

a receiver for wirelessly receiving a third signal from the wearable device that is indicative of the location of the user; and

a processor that is responsive to the third signal for generating the second signal.

In an embodiment, the base station has a predetermined location, the third signal is generated by the wearable device in response to being in proximity to the base station.

In an embodiment, the third signal is generated in response to an interrogation signal from the transmitter.

In an embodiment, the interrogation signal and the third signal are short or near range wireless signals.

In an embodiment, the interrogation signal and the third signal are transmitted by a Bluetooth protocol.

In an embodiment, the second signal is indicative of the time the third signal is received by the receiver at the predetermined location.

In an embodiment, the wearable device includes a first wearable device for generating the third signal and a second wearable device for receiving the first signal.

In an embodiment, the first wearable device and the second wearable device are, in use, spaced apart on the user.

In an embodiment, the first wearable device and the second wearable device are respectively an RFID device and a display device.

In an embodiment, the first wearable device and the second wearable device are respectively a UHF device and a display device.

In an embodiment, the RFID device and the display device are respectively a passive RFID device and a wrist mounted display device.

In an embodiment, the first wearable device and the second wearable device, in use, communicate with each other.

In an embodiment, the second wearable device is a smart phone.

According to a fifth aspect of the invention there is provided a method for providing to a user an indication of a position of the user relative to one or more members in a group of members, the method including the steps of:

containing location data for the group of members in a first database;

using a processing station for accessing the first database and being responsive selectively to the position data for generating a first signal; and

providing a wearable device for wearing by the user, the wearable device including:
(a) a receiver for receiving the first signal;
(b) a processor for processing the first signal to generate a second signal; and
(c) an interface that is responsive to the second signal for visually displaying to the user the indication of the position of the user relative to one or more members of the group of members.

According to a sixth aspect of the invention there is provided a system for providing to a user an indication of a position of the user along a predetermined path, the system including:

a first database for containing location data for the user;

a processing station for accessing the first database and being responsive selectively to the location data for generating a first signal; and

a wearable device for wearing by the user, the wearable device including:
(a) a receiver for receiving the first signal;
(b) a processor for processing the first signal to generate a second signal; and
(c) an interface that is responsive to the second signal for visually displaying to the user the indication of the position of the user along the path.

According to a seventh aspect of the invention there is provided a method for providing to a user an indication of a position of the user along a predetermined path, the method including the steps of:

containing location data for the user in a first database;

using a processing station for accessing the first database and being responsive selectively to the position data for generating a first signal; and

providing a wearable device for wearing by the user, the wearable device including:
(a) a receiver for receiving the first signal;
(b) a processor for processing the first signal to generate a second signal; and
(c) an interface that is responsive to the second signal for visually displaying to the user the indication of the position of the user along the path.

According to an eighth aspect of the invention there is provided a system for communicating with a first user participating in an event involving movement of the first user along a path, the system including:

a first interface for receiving input from a second user to provide a predetermined communication to the first user;

a processing station that is responsive to the input for generating a first signal;

at least one temporary base station that is responsive to the first signal for generating a second signal along at least some of the path; and

a wearable device for wearing by the first user, the wearable device including:
(a) a receiver for receiving the second signal;
(b) a processor for processing the second signal to generate a third signal; and
(c) a second interface that is responsive to the third signal for visually displaying to the first user the predetermined communication.

According to a ninth aspect of the invention there is provided a method for communicating with a first user participating in an event involving movement of the first user along a path, the method including the steps of:

receiving, with a first interface, input from a second user to provide a predetermined communication to the first user;

using a processing station that is responsive to the input for generating a first signal;

providing at least one temporary base station that is responsive to the first signal for generating a second signal along at least some of the path; and

providing a wearable device for wearing by the first user, the wearable device including:
(a) a receiver for receiving the second signal;
(b) a processor for processing the second signal to generate a third signal; and
(c) a second interface that is responsive to the third signal for visually displaying to the first user the predetermined communication.

According to a tenth aspect of the invention there is provided a system for providing to a plurality of users in a group of users an indication of respective positions of the users relative to one or more of the other users in the group, the system including:
a plurality of wearable devices for wearing by the respective users in the group, the wearable devices each including:
   (a) a transceiver for: receiving a first signal containing position data that is indicative of the position of the respective user relative to at least one of the other users; and transmitting a second signal containing current location data that is indicative of the current location of the device;
   (b) a location module for generating the current location data;
   (c) a processor that is responsive to: the position data for generating a fourth signal; and the current location data for generating the second signal; and
   (d) an interface that is responsive to the fourth signal for visually displaying to the respective user an indication of the position of the respective user relative to at least one of the other users;
a first database for containing historical location data for the users; and
a processing station for accessing the first database and being responsive selectively to: the historical location data for generating the position data; and the current location data for updating the historical location data.

According to a tenth aspect of the invention there is provided a method for providing to a plurality of users in a group of users an indication of respective positions of the users relative to one or more of the other users in the group, the method including the steps of:
providing a plurality of wearable devices for wearing by the respective users in the group, the wearable devices each including:
   (a) a transceiver for: receiving a first signal containing position data that is indicative of the position of the respective user relative to at least one of the other users; and transmitting a second signal containing current location data that is indicative of the current location of the device;
   (b) a location module for generating the current location data;
   (c) a processor that is responsive to: the position data for generating a fourth signal; and the current location data for generating the second signal; and
   (d) an interface that is responsive to the fourth signal for visually displaying to the respective user an indication of the position of the respective user relative to at least one of the other users;
providing a first database for containing historical location data for the users; and providing a processing station for accessing the first database and being responsive selectively to: the historical location data for generating the position data; and the current location data for updating the historical location data.

According to an eleventh aspect of the invention there is provided a system for providing to a plurality of users in a group of users an indication of respective positions of the users relative to one or more of the other users in the group, wherein:

the users each have a wearable device including:
a transceiver for receiving a first signal that is indicative of the position of the respective user relative to at least one of the other users in the group, and for transmitting a second signal containing current location data that is indicative of the current location of the device; and
an interface that is responsive to the first signal for visually displaying to the respective user an indication of the position of the respective user relative to at least one of the other users; and

the system includes:
a first database for containing historical location data for the users; and
a processing station for accessing the first database and being responsive selectively to: the historical location data for generating the first signal; and the current location data for updating the historical location data.

In an embodiment the processing station includes a plurality of base stations for sending and receiving wirelessly the first signals and the second signals respectively.

According to a twelfth aspect of the invention there is provided a method for providing to a plurality of users in a group of users an indication of respective positions of the users relative to one or more of the other users in the group, wherein:

the users each have a wearable device including:
a transceiver for receiving a first signal that is indicative of the position of the respective user relative to at least one of the other users in the group, and for transmitting a second signal containing current location data that is indicative of the current location of the device; and
an interface that is responsive to the first signal for visually displaying to the respective user an indication of the position of the respective user relative to at least one of the other users; and

the method includes:
providing a first database for containing historical location data for the users; and
providing a processing station for accessing the first database and being responsive selectively to: the historical location data for generating the first signal; and the current location data for updating the historical location data.

In an embodiment the method includes the step of sending and receiving wirelessly the first signals and the second signals respectively with a plurality of base stations.

According to a thirteenth aspect of the invention there is provided a system for providing a user with timing data indicative of one or more characteristics of the user's progression along a predetermined path, wherein:

the user has available a wearable device including:
a transceiver for receiving a first signal that is indicative of the timing data, and for transmitting a second signal containing current location data that is indicative of the current location of the device; and
an interface that is responsive to the first signal for visually displaying to the user the timing data or other data derived from the timing data; and

the system includes:
a first database for containing historical location data for the users; and
a processing station for accessing the first database and being responsive selectively to: the historical location data for generating the first signal; and the current location data for updating the historical location data;
wherein the processing station includes a plurality of base stations for sending and receiving wirelessly the first signal and the second signal respectively to and from the device.

In an embodiment the base stations send wirelessly the first signal by broadcast transmission.

In an embodiment the wearable device transmits the second signal by broadcast transmission.

In an embodiment the wearable device transmits the second signal by unicast transmission.

In an embodiment the one or more characteristics are selected from: a position of the user relative to another user in a group of users; an interval since the user passed a first predetermined waypoint along the path; and an anticipated interval until the user reaches a second predetermined waypoint along the path.

According to a fourteenth aspect of the invention there is provided a method for providing a user with timing data indicative of one or more characteristics of the user's progression along a predetermined path, wherein:

the user has available a wearable device including:
a transceiver for receiving a first signal that is indicative of the timing data, and for transmitting a second signal containing current location data that is indicative of the current location of the device; and
an interface that is responsive to the first signal for visually displaying to the user the timing data or other data derived from the timing data; and

the method includes the steps of:
providing a first database for containing historical location data for the users; and
using a processing station for accessing the first database and being responsive selectively to: the historical location data for generating the first signal; and the current location data for updating the historical location data;
wherein the processing station includes a plurality of base stations for sending and receiving wirelessly the first signal and the second signal respectively.

According to a fifteenth aspect of the invention there is provided a system for providing a user with timing data indicative of one or more characteristics of the user's progression along a predetermined path, wherein:

the user has available a wearable device including:
a transceiver for receiving a first broadcast signal that is indicative of the timing data, and for broadcast transmitting a second signal containing current location data that is indicative of the current location of the device; and
an interface that is responsive to the first signal for visually displaying to the user the timing data or other data derived from the timing data; and

the system includes:
a first database for containing historical location data for the users; and
a processing station for accessing the first database and being responsive selectively to: the historical location data for generating the first broadcast signal; and the current location data for updating the historical location data.

In an embodiment the processing station includes a plurality of base stations for sending and receiving the first broadcast signal and the second broadcast signal respectively.

According to a sixteenth aspect of the invention there is provided a method for providing a user with timing data indicative of one or more characteristics of the user's progression along a predetermined path, wherein:

the user has available a wearable device including:
a transceiver for receiving a first broadcast signal that is indicative of the timing data, and for broadcast transmitting a second signal containing current location data that is indicative of the current location of the device; and
an interface that is responsive to the first signal for visually displaying to the user the timing data or other data derived from the timing data; and

the system includes:
a first database for containing historical location data for the users; and
a processing station for accessing the first database and being responsive selectively to: the historical location data for generating the first broadcast signal; and the current location data for updating the historical location data.

In an embodiment the processing station includes a plurality of base stations for sending and receiving the first broadcast signal and the second broadcast signal respectively to and from the device.

One embodiment provides a computer program product for performing a method as described herein.

One embodiment provides a non-transitive carrier medium for carrying computer executable code that, when executed on a processor, causes the processor to perform a method as described herein.

One embodiment provides a system configured for performing a method as described herein.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, priority or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

### BRIEF DESCRIPTION OF THE DRAWINGS

Embodiments of the invention will now be described, by way of example only, with reference to the accompanying drawings in which:

FIG. 1 is a schematic representation of a system for providing to a user an indication of a position of the user relative to one or more members in a group of members;

FIG. 2 is a schematic representation of the deployment of the system of FIG. 1 for a race;

FIG. 3 is a schematic representation of the location data for one of the users of the system of FIG. 1;

FIG. 4 is a schematic representation of the functional elements of one of the wearable devices of FIG. 1;

FIG. 5 is a plan view illustrating the form of the wearable device of FIG. 4;

FIG. 6 is a schematic representation of the functional elements of one of base stations used in the system of FIG. 1;

FIG. 7 is a schematic representation of the steps of operation of the system of FIG. 1;

FIG. 8 is a schematic representation of some of the steps of FIG. 7 in more detail;

FIG. 9 is a schematic representation of some further steps of FIG. 7 in more detail.

FIG. 10 is a schematic representation of a further embodiment of the invention making use of a plurality of spaced apart wireless base stations; and

FIG. 11 is a schematic representation of one of the base stations of FIG. 10.

### DETAILED DESCRIPTION

Described herein are a system and method for providing a user with timing data indicative of one or more characteristics of the user's progression along a predetermined path and a system and method for providing to a user an indication of a position of the user relative to one or more members in a group of members.

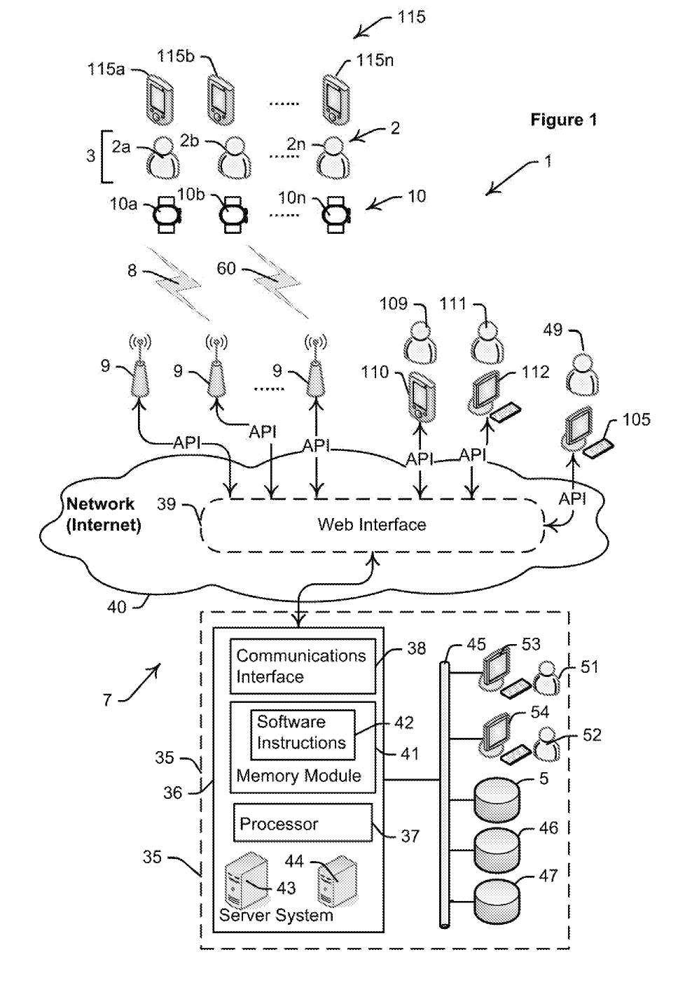

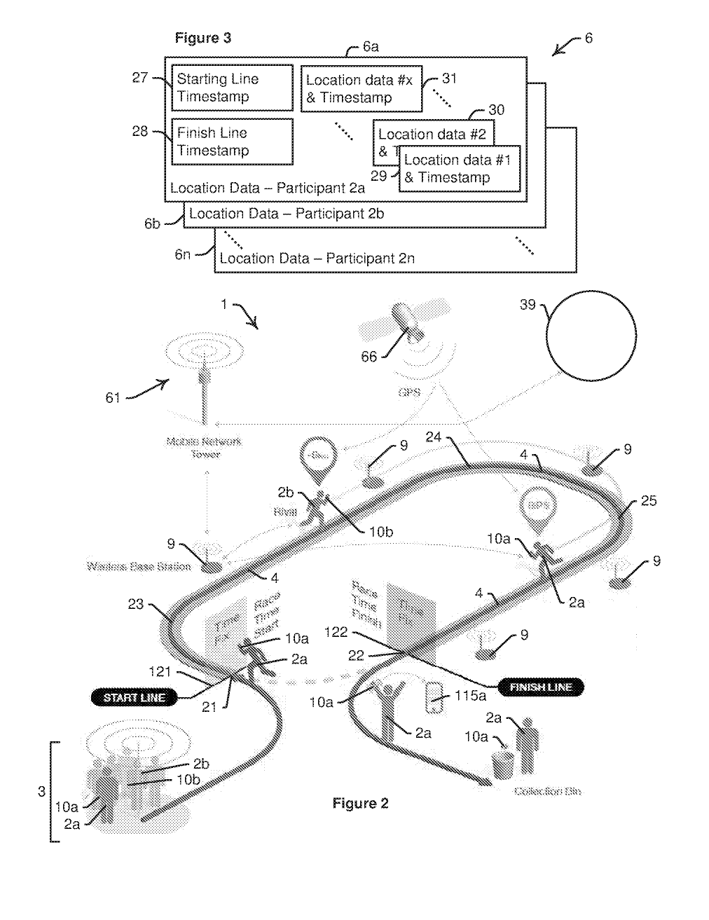

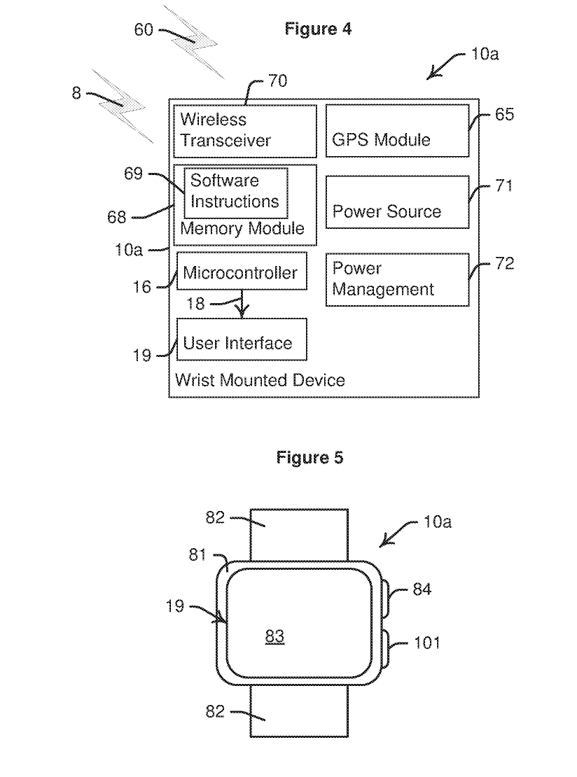

Referring to FIG. 1 and FIG. 2 there is illustrated a system 1 for providing to a plurality of users in a group of users—in the form of a plurality of race participants 2 in a group 3 of participants 2a, 2b, . . . and 2n, all of whom are participating simultaneously in a community running race along a predetermined path 4—with an indication of respective positions of the participants 2 relative to one or more of the other participants 2 in group 3. System 1 includes a first database 5 for containing historical location data 6 (as illustrated in FIG. 3) for each of participants 2 (in the form of record 6a, record 6b, . . . , record 6n respectively). A processing station 7 accesses database 5 and is responsive selectively to data 6 for generating first signals 8 that are wireless transmitted from a plurality of temporary base stations 9 that are physically spaced apart along path 4. A plurality of wearable devices, in the form of a plurality of wrist mounted devices 10 (and more specifically devices 10a, 10b, . . . , 10n), are worn by respective participants 2a, 2b, . . . , and 2n in group 3. As best shown in FIG. 4, and by way of example, device 10a includes a receiver, in the form of a wireless transceiver 15, for receiving signals 8. A processor, in the form of a microcontroller 16, processes signal 8 to generate a second signal 18. An interface, in the form of a user interface 19, is responsive to signal 18 for visually displaying to the respective participant 2a the indication of the position of the participant 2a relative to one or more of the other participants 2b, . . . , 2n in group 3.

In this embodiment microcontroller 16 is an ARM coretex M3 processor. However, in other embodiments different processors are used.

Station 7 is responsive to the historical location data 6 for deriving timing data about the users. In this specific embodiment the timing data is position data, in that it is indicative of the position of the users relative to other users. However, in other embodiments the timing data includes indications of other aspects of the users' progression along path 4 that are not directly indicative of the relative position of those users.

While this embodiment is described with reference to a running race, it will be appreciated by those skilled in the art, particularly in light of the teaching provided herein, that other embodiments are applicable to other events. Exemplary other events include triathlons, bike races, open water swimming events, biathlons, and other such events whether fully completed individually or by a team of individuals.

As best shown in FIG. 2, path 4 includes a start line 21 where the race begins for participants 2 and a finish line 22 where the race ends. These two lines define two waypoints along path 4, in that station 7 is provided with location data for those lines. This location data is typically GPS coordinates for those respective lines. However, in other embodiments, different coordinates are used. Path 4 includes a plurality of other waypoints, which are exemplary indicated as waypoints 23, 24 and 25. The coordinates for all the waypoints are stored by station 7 in database 5. It will be appreciated that in FIG. 2 the waypoints indicate, in addition to the start line 21 and the finish line 22, any significant changes in direction of path 4. This allows the location data for the waypoints to provide station 7 with a relatively accurate geographic indication of path 4 in a digital format. In other embodiments, more or less waypoints are used.

It will be appreciated that for large scale running events such as those this embodiment is particularly directed to, path 4 extends through public areas such as roads (that are temporarily closed for the race), parks, car parks, trails, open areas and water bodies (especially for triathlons). It is usual for path 4 to have a length of a few kilometres up to many kilometres. It is also possible for multiple paths to be included in a single event, such as when a half marathon and a full marathon are being run in parallel in a given location. The longer the event in distance terms typically the larger the number of waypoints as the direction of path 4 will change many times along its length.

Station 7 is responsive to the participants 2a, 2b, . . . , 2c crossing lines 21 and 22 to update the location data 6 held in database 5 for those respective participants. More particularly, data 6 includes a starting time record 27 that station updates with the GPS coordinates of start line 21 and a timestamp indicative of the time participant 2a crosses start line 21. Similarly, data 6 includes a finish time record 28 that station updates with the GPS coordinates of finish line 22 and a timestamp indicative of the time participant 2a crosses finish line 22. These records are therefore each indicative of the location of participant 2a at different times. Moreover, during the race—that is, as participant 2a is progressing along path 4—station 7 is responsive to intermediate location data being received (in the form of GPS coordinates) for further updating data 6. For example, and as illustrated in FIG. 3, this updating of data 6 for participant 2a results in progressively defining additional historical records 29, 30, and up to 31 that are added to record 6a. Although only three such additional records are explicitly illustrated it will be appreciated that during the race there will be, in the embodiment, a new additional record added about every thirty seconds for each of the participants. In some embodiments the rate of update of record 6a is greater to provide for additional accuracy and location certainty. However, in other embodiments a lower rate of update is used. Moreover, in some embodiments the rate of update is different for different participants. For example, participants are able to pay a premium to have a greater rate of update of the associated data 6.

The above progressive accumulation of the location data 6 for each participant 2 provides, by the end of the event, an historical chronological and location-based record of the progression of those participants along the path. It will be appreciated that a given participant is able to utilise system 1 for more than one event—that is, for time spaced progressions about a plurality of predetermined paths or for time spaced progressions along the same path 4. Accordingly, over weeks, months and years, that participant will generate with system 1 an historical record of progressions about the relevant paths. This allows system 1 to selectively deliver up to the participants—via respective online devices—the historical location data itself (for use in other apps, devices, or programs) or an analysis of that data. This functionality is also extended to provide a virtual participant and historical race records that are able to be uploaded. Accordingly, the user is able to gain comparisons with other participants, virtual participants, a “pacer” participant, amongst others. In this embodiment the historical location data provides each participant with the ability to ascertain his or her ranking, at any time during the race, within the one or more categories in which that participant was enrolled (such as outright, gender, age group, work group, etc.) Additionally, as this location data includes standard GPS data, the latter is also able to be made available to enable individual participants to make comparisons with other race participants against one or many different characteristics. This functionality is also extended to provide a virtual participant and historical race record that is able to be uploaded onto device 10 for future races on the same course to provide the participant, during the next race on that same course, with real time point of comparison. Furthermore, system 1 is able to be configured to allow participants to upload their respective location data 6 (and with appropriate permissions the data 6 from another participant) and use this as a training aid. That is, the participant is able to upload, into his or her third party GPS watch, the required software and data that allows that participant to run a virtual race against his or her earlier attempt, or against an earlier attempt by another participant. It will also be appreciated that the participant is able to use another wearable electronic device, such as a GPS enabled smart phone, to perform the function mentioned above for the GPS watch.

The use of data 6 by station 7 to generate signal 8 will be described in more detail below.

Referring again to FIG. 1, although station 7 includes stations 9, the latter are physically spaced apart in the vicinity of path 4, while station 7 itself is located at a fixed computer facility 35 that is remote from path 4. In other embodiments, station 7 is located in a portable structure for movement between different paths 4 and, hence, in use, is much closer to stations 9. Station 7 has a server system 36, including a processor 37 and a communications interface 38 that is controlled by processor 37 for creating a web interface 39 using a communications network such as the internet 40. This allows for communication to be established between system 36 and stations 9. In other embodiments use is made of a different communications network, such as a cellular telephone network or an intranet. In further embodiments, use is made of a combination of two or more such networks.

System 36 also includes a memory module 41 that contains software instructions 42 which are accessed and executed by processor 37 to enable the implementation of the functionalities provided by system 1.

A data bus 45 allows communication between the components within facility 35, for example, to allow updating of the location data 6 in database 5. However, other communications are also required to enable the operation of the associated IT infrastructure, as would be appreciated by those skilled in the art. For example, also connected to bus 45 is a plurality of other databases 46 and 47 which contain additional data required for the underlying operation of system 36, the storage of reports and other analysis of data 6, and/or records of communications with participants and other interested parties.

Furthermore, in this embodiment facility 35 is owned and maintained by an operator (not shown) that is a corporate entity that provides event timing services to an event organiser 49. In this embodiment the operator employees personnel to respectively act as an administrator 51 of system 36 and a support assistant 52 for system 36. These personnel have access privileges to system 36 (although different access privileges) via respective user terminals 53 and 54. In other embodiments, these personnel gain access to system 36 via interface 39 instead of or in addition to being able to gain access via the respective terminals.

In other embodiments facility 35 is owned and maintained by event organiser 49. In even further embodiments other commercial arrangements are used in respect of the ownership of the hardware and software and the deployment of system 1 to provide the required functionality. For example, the base stations and wearable devices (and associated equipment) are able to be rented, and use made of a “pay as you go” cloud-based computing system to provide the functionality of facility 35.

It will be appreciated that in other embodiments different hardware configurations are used to achieve the same functionalities.

Stations 9, in addition to wirelessly broadcast transmitting signals 8, receive wirelessly third signals 60 from devices 10 that are indicative of the location of the respective participants. These signals 60 are communicated back to system 36 at which time processor 37 is responsive to updating data 6. It will be appreciated that in this embodiment devices 10 broadcast signals 60 and that these signals contain current location data for the respective devices 10. System 36 is responsive to that current location data for updating data 6. As in, system 36 is responsive to the current location data to convert it into historical location data. In the interim, or within a short period, devices 10 obtain further current location data and broadcast a corresponding signal 60, to which system 36 is then also responsive to, and so on.

While only thee spaced apart base stations 9 are explicitly illustrated in FIG. 2 it will be appreciated that more or less are able to be used to suit the event (which in this example is a running race) to which system 1 is being applied. The range of these specific stations 9 is about 1 km and, hence, to provide a continuous field of communication along a 10 km path the use of about 10 such stations is required. However, while that may allow communication of signal 8 (and receipt of signal 8 by devices 10) it may not accommodate the effective transmission of signal 60 from all of devices 10 to at least one of stations 9. Accordingly, to provide the continuous field of communication the range of devices 10, which in this embodiment is also about 1 km, has to be taken into account. The spacing between stations 9 in this embodiment is such that while participant 2a stays on path 4 signal 60 will be detected by at least one of stations 9. This includes making use of a safety margin to account for the nature of path 4 (such as direction changes), any intervening terrain and buildings along path 4, and any likely sources of electromagnetic interference. In other embodiments stations 9 are located along path 4, but not to provide a continuous field of communication with devices 10. An example of such an embodiment has stations 9 located to ensure the communication field is established about key waypoints along path 4.

It will be noted from FIG. 2 that stations 9, while communicating with system 36 via interface 39 and the internet 40, make additional use of a cellular telephone network 61. That is, each of stations 9 communicates individually with the cellular network and interface 39. In other embodiments a subset of stations 9 communicate with interface 39 directly through the cellular network and the remainder of stations 9 communicate via one or more of the subset of stations. In other embodiments, stations 9 are daisy-chained or otherwise configured (either as a standalone network, or operating with a public network) to allow the signals 8 and 60 to be passed between system 36 and devices 10.

Each wearable device 10, as exemplified in FIG. 4 as device 10a, includes a location device in the form of a Quectel GPS module 65. However, in other embodiments a uBlox GPS module is used. In further embodiments a different GPS module is used. It will be appreciated that module 65 (and the like modules in other devices 10) interact with a plurality of spaced apart GPS satellites 66, such as that illustrated in FIG. 2 (although only one satellite is shown), for obtaining GPS coordinates that are indicative of the location of module 65. That is, device 10a, in accordance with the operation of microcontroller 16 obtains current location data for device 10a, and microcontroller 16 is responsive to the acquisition of that current location data for generating signal 60.

The reference to a GPS system as used in this specification, unless the context clearly indicates otherwise, is not limited to a reference to the GPS system but also to other available global positioning systems such as those provided by, for example, GLONASS and Galileo.

A number of characteristics of the two GPS modules mentioned above include:

| | | | Size | |
|---|---|---|---|---|
| Manu- | Device/ | | (excluding | Power |
| facturer | Part | Support | antenna) | consumption |
| Ublox | EVA-7M | GPS/ | 7 × 7 × 1.1 mm | 16 mA (power |
| | | GLONASS | | save 4 mA) |
| Quectel | L70-R | GPS (L76 has | 10.1 × 9.7 × 2.5 mm | 13 mA (power |
| | | GLONASS | | save 1.6 mA) |
| | | support | | |
| | | as well) | | |

The Ublox module is advantageous as it provides, for a relatively small cost in terms of price and power consumption, support for both GPS and GLONASS location sources. This provides for an increased accuracy as there will be more places where location data is able to be derived through use of one or the other locating systems.

It will be appreciated that the precision delivered by a GPS/GLONASS module will vary depending upon the location and the conditions at the location. For both of the modules identified above the GPS precision is quoted as being 2.5 m CEP (Circular Error Probability), which equates to 50% of all location readings being within a 2.5 m radius circle around the actual location.

As with all such GPS modules, they only work outdoors and the stated performance will be achieved when there is open sky and sufficient satellites. To assist manage this issue, devices 10 will include a resident location algorithm that accesses local stored data about the path and the recent location history (and the associated timestamps) to provide an estimate of the location of the device if a GPS fix cannot be obtained within a predetermined period.

It will be appreciated that the GPS/GLONASS module will include an antenna. In the present preferred embodiments use is made of an antenna that is integrated into module 65 to allow for optimum antenna performance for the available form factor of device 10. In other embodiments use is made of an “off the shelf” GPS antenna that is separately attached to module 65.

It will be noted that device 10a includes a non-volatile flash memory module 68 for storing software instructions 69 that are executed by microcontroller 16 to provide the functioning of device 10a. However, module 68 is also used by microcontroller 16 to store or buffer location data (and the associated timestamps) for batch transmission (via signal 60) to system 36. Moreover, signal 8 includes position data that is extracted by microcontroller 16 and stored in memory for immediate or later display on interface 19 to participant 2a. Module 68 also stores other data such as route waypoints.

In other embodiments use is made of other signals to replace, supplement, refine or verify the GPS coordinates provided by module 65. For example, in one such embodiment microcontroller 16 is responsive to signals from one or more of stations 9 for deriving an indication of location which is used in combination with the GPS coordinates from module 65 to verify the location of participant 2a along the path. In other embodiments device 10a includes additional hardware to allow detection of mobile telecommunications signals such as those provided by cellular communications towers. This allows for techniques such as triangulation and multilateration to replace or supplement the available GPS coordinates. It will also be appreciated that participant 2a will typically be progressing along path 4 which will provide an additional reference point for any triangulation or multilateration calculation that is undertaken. Moreover, microcontroller 16 is able to retain a number of past GPS coordinates (and the associated timestamps) with module 68 to act as a further reference when determining the current location of participant 2a.

In another embodiment stations 9 are placed at predetermined geographic locations to offer a further and accurate reference point for determining/verifying the location of the participants along the path.

Device 10a includes a receiver in the form of a transceiver 70 to not only allow reception of signal 8 but also the broadcast transmission of signal 60. In this embodiment transceiver 70 is a 900 MHz GFSK wireless transceiver, which offers a compact form factor, energy efficient operation and a wide range of options. These transceivers are able to be configured to operate across a substantial part of the 900 MHz frequency range. In other embodiments different transceivers are used.

In other embodiments, transceiver 70 is a Bluetooth transceiver communicating, for example, with typically one of stations 9. However, in other embodiments, the transceiver is an LTE-M module, and communicates with a mobile (cellular) telecommunications tower.

Device 10a includes an onboard power source in the form of a rechargeable lithium polymer battery 71. This battery is selected both for its slim form factor, and due to having a high energy density (that is, a relatively high energy storage per unit volume). In other embodiments different or additional energy storage devices are used, such as capacitors, supercapacitors, or other types of batteries. In this specific embodiment use is made of a rechargeable battery to allow reuse of device 10a. In other embodiments, where such re-use is not required, cheaper forms of battery are used.

A further component included in device 10a is a power management circuit 72. This circuit manages the operation of battery 71 to prevent damage during both the discharging and charging of battery 71. Circuit 72 also provides a regulated power supply to the electrical components within device 10a.

Device 10a includes external pins (not shown) for allowing an external source of power to be connected to circuit 72 such that battery 71 is able to be charged between uses. In other embodiments device 10a is configured for wireless charging.

The illustration of device 10a in FIG. 4 provides a functional overview. The form device 10a takes in the present embodiment is similar to that of a digital wrist watch such as that illustrated in FIG. 5. More particularly, device 10a includes a generally rectangular plastic prismatic housing 81 that contains all the functional blocks set out in FIG. 4. A pliant plastic strap 82 extends outwardly from opposite sides of housing 21 to define two free ends (not shown) that support complementarily and releasably engageable elements of a fastening system (not shown). This allows device 10a to be easily attached to and removed from the wrist of participant 2a, and to be securely worn on the body of the respective participant for the duration of the race. In this embodiment the fastening system includes two inter-engageable plastic clips. However, in other embodiments different fastening systems are used, such as loop and hook fastening system, or metal fastenings, or a combination of these. In further embodiments, strap 82 is a resiliently deformable continuous loop that participant 2a is able to expand to slip over his or her hand, and which then contracts to retain device 10a on the wrist of participant 2a. In further embodiments strap 82 is substituted by a fastening device such as a clip.

In other embodiments device 10a is secured to another part of the body of participant 2a. For example, in one such other embodiment device 10a is secured to an ankle of participant 2a. A further example has device 10a secured to an arm of participant 2a.

In a further embodiment housing 81 is detachably mounted to strap 82. This allows participants 2, once crossing line 22, to simply remove housing 81 and have it placed in a collection bin. Strap 82 remains on the wrist (or other part of the body) and is retained by the participants. In some embodiments strap 82 includes indicia indicative of the event to provide official memorabilia for the participants and a reminder about how to access the participant's timing data. In other embodiments strap 82 includes marketing indicia associated with one or more parties involved with the event.

In FIG. 5 interface 19 is defined in part by a generally rectangular flat monochrome display screen 83 that selectively displays alpha numeric characters for viewing by participant 2a. In this specific embodiment screen 23 displays the current ranking of participant 2a relative to the other participants 2b, . . . , 2n, where the ranking is assessed in accordance with the extent of the progression of those participants along path 4. That is, screen 83 will display a number that is representative of the position in the race presently held by participant 2a relative to the remainder of the participants in group 3. In some embodiments group 3 includes all the participants in the race, while in other embodiments group 3 is a subset of all the participants in the race. For example, the subset (or subsets) may be selected by event organiser 49 based upon one or more of: gender; age; employer; other nominated affiliation; or one or more other categorizations.

In use, microprocessor 16 operates screen 83 in a standby mode to reduce power consumption. The microprocessor is responsive to participant 2a depressing button 84 to access module 68 and obtain the last stored position data for participant 2a.

This position data will have been communicated to device 10a by signal 60 from system 36. Following from this, microcontroller 16 generates signal 18 which powers up screen 83 to display the indication of the position of participant 2a relative to the other participant in group 3. After a predetermined timeout period—in this embodiment of five seconds—microcontroller 16 returns screen 83 to the standby mode.

In other embodiments use is made of other user interfaces, such as touch displays, or graphical displays, or e-ink displays. In such embodiments use is also made of a vibrate function to provide a physical alert to participant 2a to the receipt of selected timing data. For example, device 10a is able to be configured to provide a vibration alert to participant 10a if the participant's position rises or falls above or below pre-set thresholds. Another example, is to provide a vibration alert at the completion of each kilometre run by participant 2a. It will be appreciated by those skilled in the art, given the benefit of the teaching herein, that many other alerts are able to be defined and delivered to the participants.

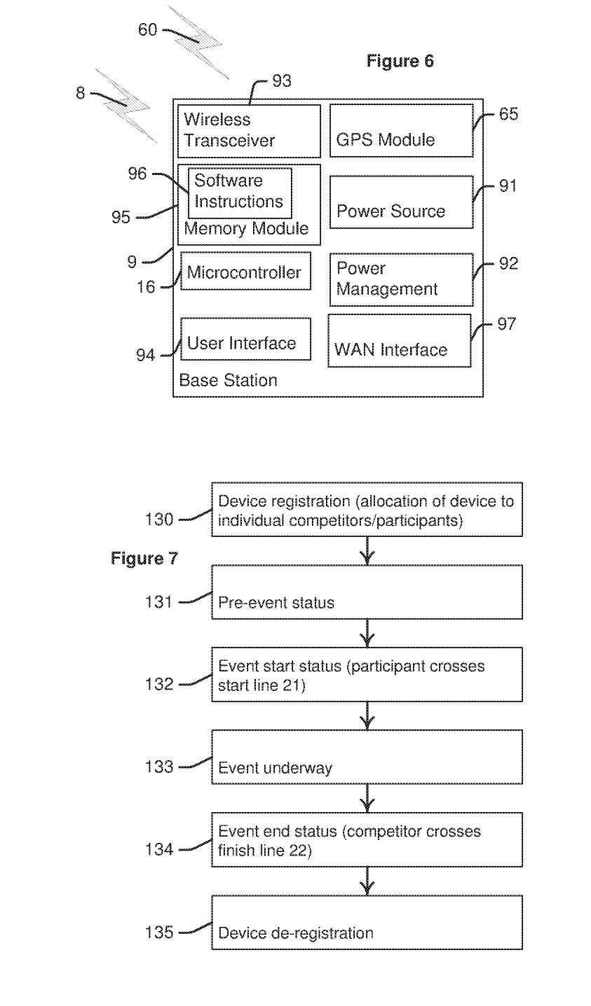

Reference is now made to FIG. 6 where there is illustrated schematically one of stations 9, where corresponding features are denoted by corresponding reference numerals. This station includes an onboard power source in the form of a rechargeable lithium polymer battery 91. However, in other embodiments use is made of a different battery type or energy storage device. For example, in some embodiments use is made of one or more non-rechargeable batteries. Battery 91 has a greater capacity than battery 71 both due to the available volume to store the battery and the fact that station 9 is able to remain stationary during the event. Accordingly, lightness is not such a critical design feature for station 9.

A power management circuit 92 is included within station 9 that is similar in function to that used in devices 10. However, it is up-rated to deal with the larger currents encountered with battery 91 relative to battery 71.

Station 9 includes a plurality of transceivers 93 (only one explicitly illustrated) that are similar to transceivers 70. This facilitates communication with multiple devices 10 in quick succession. As will be appreciated, as a race with a large number of participants takes place there will be for a given station 9 a few initial demands on the available bandwidth as the leaders of the race approach. There will then be a relative surge of communications (and a peak in the need for bandwidth) as the bulk of the participants pass through the field provided by station 9, and then a receding tail of communications as the final participants pass through the field provided by station 9. In this embodiment each station 9 includes these multiple transceivers 93 to reduce the need for additional stations while still accommodating the bandwidth demands. Moreover, in some embodiments, microcontroller 16 is responsive to the available bandwidth for including within signal 8 a command to devices 10 in the field provided by station 9 to temporarily reduce either or both of: the sampling rate for the current location data; and the generation of signal 60.

Using the above configuration, based on a 900M Hz GFSK radio link, each packet is able to contain up to 64 bytes of data. Using a 50 kbps GFSK configuration, each packet takes ˜13 ms to transmit. Applying a safety margin (by using a 15 ms transmit time) for an event having 10,000 competitors and a route (path) with 1,000 waypoints used as a basis for calculations, it would take about 15 seconds to retrieve the required GPS information from devices 10 and relay the position information back to devices 10. That is, every 15 seconds it would be possible to have the position data for each individual participant 2 updated on all devices 10. Further examples of the total loop time will be provided below in the context of different stages of the event. It will be appreciated that while similar principles will apply in other embodiments, the precise performance parameters will vary with the nature of the communications system or system that is used, the number of participants, the data required by those participants, and the quantity of data required to be transmitted due to the nature of the system architecture, amongst others.

In the context of a running event that occurs over an hour or more, an update of the position to thousands of participants every fifteen seconds is sufficient to be substantially real time feedback of that position. This effective real time performance is enabled by the use of a broadcast transmission of the position data or other timing data from system 1 to each of devices 10. That is, there is a broadcast transmission of the position data from stations 9 to each of devices 10. The function is further enabled by the use of a broadcast transmission of the location data from devices 10 to system 1. That is, the broadcast transmission from each of devices 10 of the current location data to at least one of stations 9.

The above functionality is also able to be delivered by the above embodiment due to the concise nature of the data that is broadcast. Both the current location data and the position data are small packets of information, which allows updated packets to be more frequently transmitted. Moreover, system 36 operates to compose the position data such that minimal processing is required by devices 10.

A GPS module 65 is also included within station 9 to assist with: spectrum management (based upon an automated spectrum management algorithm based on location); placement of the stations along path 4 at appropriate intervals in preparation for the event (in that the distance from the adjacent stations or stations will be accessible at each station); and retrieval of stations once the event is completed, or at least sufficiently completed that station 9 is able to be decommissioned.

Station 9 includes a user interface 94 having a plurality of LED's to indicate one or a number of possible operational states. This interface will also include a plurality of manually depressible buttons (or virtual buttons on a touch screen) to allow an operator to provide manual control inputs to station 9, such as when commissioning and decommissioning the station for the event.

Stations 9 also include an inbuilt test software for allowing the operational state of each station to be remotely tested and verified (typically from facility 35) prior to the start of the race. This is referred to as pre-race testing of stations 9. Moreover, during the race system 1 is configured to periodically undertake further remote testing of the stations to regularly monitor the performance and status of those stations. This allows for the early detection of any faults or inactivity of any one or more of the stations and for action to be taken to either replace the relevant station or to have its performance otherwise remedied. While this functionality is administered by system 36, the relevant status reports about the operation of stations 9 are typically pushed via interface 39 to a mobile web-enabled device carried by a field administrator (not shown) to allow rapid response to any technical issues.

Due to the need in this embodiment to buffer the data being exchanged between devices 10 and interface 39, station 9 includes a memory module 95 with greater capacity than module 68. For module 95, in addition to having to store software instructions 96, has to have capacity to store configuration data and the buffered data. Accordingly, module 95 includes both flash memory (non-volatile) and RAM.

Further to the above, station 9 also includes a WAN backhaul interface 97 in the form of a mobile data module. This module is 4G compatible and has pentaband support to provide reliable data performance and global coverage.

Due to the inclusion of multiple transceivers 93 and a mobile data module 97, the current drain (at the voltage provided by battery 91) is in the order of 700 mA for the duration of the event. This includes 4×100 mA for transceivers 93, 250 mA for mobile data module 97 and 50 mA for the other circuitry. To provide a battery life of five hours, battery 91 has a capacity of 3.5 Ah. In other embodiments different battery capacities are used. For example, in some embodiments, station 9 also includes a power amplifier to achieve additional range performance. Accordingly, to have the same operational lifetime, and safety factors, a battery is used having a greater capacity than battery 93. Moreover, for a longer event such as a marathon the battery life for at least some of the stations (depending upon the nature of the course) will need to be about seven hours. In even longer events, such as used in an ironman triathlon format, the battery is required to support about seventeen hours of operation. In some embodiments, where stations 9 have only shorter operation durations for a given event due to battery capacity constraints, use is made of a time-staggered implementation were the stations are placed apart by about 500 metres and alternate stations operate for the first part of the event, and the remainder for the latter part of the event. This principle is able to be extended to more than two sets of stations operating in a time-staggered manner.

In summary, stations 9 send position data to devices 10 and receive current location data from devices 10 and are temporarily placed to provide the desired communication with those devices as the race (or other event) takes place. The stations are battery powered to provide more flexibility in placement, and have the following advantageous characteristics:
Use the existing mobile data network as backhaul.
Allows a spacing between the stations to be in the order of 1 km subject to geography and other transmission impediments.
Different wireless channels are able to be allocated for different purposes/services.
At least two broadcast channels will be used to broadcast position data (such as current runner order). One is a standard service, and another is a high priority/premium service that provides an increased rate of update of the position data.
The use of multiple transceivers to allow simultaneous broadcast on multiple channels.

The 900 MHz radio spectrum has been selected due to the balance it offers in terms of range, performance, and form factor which are well suited to the present application. It is noted that this spectrum does vary between different regions globally (for example, in the US it extends from 902 to 928 MHz, in Australia from 918 to 926 MHz, and EU from 863 870 MHz) however this has not be found to be problematic for the embodiments of the invention.

In other embodiments, such as those described below, use is made of different wireless spectrums for communication within the system. For example, where use is made of Bluetooth protocol, it is a standard operating frequency worldwide. For the LTE-M or like standard, the spectrum is often different on a country-by-country basis, and even on a regional basis within a country. Accordingly, a skilled addressee would appreciate the need to appropriately configure the hardware and software used in any specific embodiment to enable proper implementation of that embodiment in a given location.

It will be understood that devices 10 are sampling GPS coordinates that are used to provide what is at that time the current location data for the respective participants 2. This data is communicated to station 7 together with the relevant timestamps (by way of signals 60) which allows database 5 to progressively build, as the race unfolds, a collection of records that map the progression of the participants along path 4. Processor 37 is responsive selectively to this collection of records for calculating the ranking of each of participants 2 relative to each other—that is, position data for each participant—and having that position data pushed out to the relevant participants (in the form of a unique signal 8 that is sent to respective devices 10). This allows a substantially real time provision of ranking (or other position data or timing data) to all the participants during the race. In other embodiments the position data is supplemented or substituted with additional timing data. This timing data is able to be, for example, the elapsed time since the event commenced, the elapsed time since the participant crossed line 21, an indication of the time interval that separates the participant and the participant with the next lowest ranking in the group, an indication of the time interval that separates the participant from the participant that has the next lower ranking in the group, the anticipated time remaining for the participant to arrive at line 22, the estimate of the time of day that the participant will arrive at line 22 based upon a current rate of progress along path 4, or a predetermined or specified different rate of progress, and the like. It will be appreciated by those skilled in the art that many other types of timing data and position data are also available.

It will be appreciated that while reference is made above to “real time” this is not to be understood as being instantaneous provision of timing data (such as position data) to the participant but, rather, that the data is provided sufficiently timely to be meaningful in the context of the event to which the invention is applied. For example, in longer races a lower sampling of location data than every fifteen seconds is sufficient as positions do not change as often. Alternatively, if a number of participants are physically close—that is, running together—then the need for accuracy from devices 10 is diminished as the feedback will be immediately available to those participants from the physical surrounds.

In the context of a race having a path with a length of 10 km it has been determined that a sample rate for the location data of about every 30 seconds is typically sufficient. However, it has also be found beneficial to have an increased rate of sampling just prior to stop line 22, and at any key waypoints along path 4. Moreover, in some races the participants and/or groups of participants are offered the option of greater sampling rates (and hence greater accuracy in the position data). This aspect of the operation of system 1 will be described in more detail below.

In the above embodiment the position data displayed on screen 83 includes the positional ranking of participant 2a relative to the remainder of the participants 2b, 2n. In other embodiments different or additional position data or other timing data is also determined by processor 37 and encoded within signal 60. In these embodiments microprocessor 16 extracts all the available position data (in those instances it is made available) and includes it within signal 18. Participant 2a is able to cycle through the individual position data that is available by manually depressing a button 101 on the side of housing 81. Examples of such additional position data include one or more of:
The time elapsed since participant 2a crossed start line 21.
The time elapsed since the first participant crossed start line 21.
The distance travelled/distance remaining.
Current pace (minutes per kilometre, minutes per mile etc.)
Expected finish time at current pace.
Current position (ranking) overall.
Current position in category.
Distance behind next runner in category.
Distance behind next nominated rival (defined at enrollment).
Time ahead of or behind a prior traverse of the path by the same participant. (Regardless of whether the earlier traverse was during a race or a practice run).
Time ahead of or behind a prior traverse of the path by another participant.
Time ahead or behind a predefined ‘pacer’ time. That is, the participant is able to enter, prior to starting the race (or practice run) a target time or goal for traversing the path.

In some embodiments device 10a includes one or more LEDs to provide additional feedback to participant 2a. However, in further embodiments device 10a does not included any LEDs or buttons to simplify the design and to contain the cost of production and operation.

It will be appreciated from the above description that system 1 provides each device 10 with tailored and specifically calculated position data (or other timing data) that allows those devices to provide to respective participants 2 an indication of the position of those participants relative to one or more of the other participants in group 3. However, the functionality of system 1 also allows selectively for the position data to be communicated to others. For example, event organiser 49 is able to query database 5 by first gaining access to system 36 via interface 39. In this embodiment, and as shown in FIG. 1, organiser 49 makes use of a desktop computer 105 to securely connect with interface 39. Once logged in, organiser 49 is able to initiate queries of database 5 and to be delivered reports, alerts and statistics about the race and its progress. This functionality allows organiser 49 to gain a better appreciation for the progress of the participants and to deliver superior commentary about the event and its progress to spectators and other interested parties such as police and safety officers. It also allows for the identification and location of slow (and potentially injured or distressed) participants and the early dispatch of assistance to those participants.

System 1 also allows pre-approved followers of the individual participants 2 to gain access to at least selected feedback about the location and/or position of the relevant participant. For example, in FIG. 1, there is an authorised follower 109 for participant 2a. That is, when enrolling in system 1 (as will be described in more detail below) participant 2a identified follower 109 as being authorised and follower 109 was then also enrolled in system 1 as a follower for that participant. Accordingly, follower 109 is able to use a web enabled device, such as a smartphone 110, to access system 1 via interface 39 using a unique username and password. System 1 then allows follower 109 to run selective queries in database 5 to gain reports about the location and/or position of participant 2a.

Other forms of users of system 1 include media outlets that have an interest in reporting on the race, or any one or more of the participants in the race (or other events). In the FIG. 1 embodiment a representative 111 of a media outlet uses a desktop computer 112 (which in other embodiments is another web enabled device) to connect with interface 39 and log into system 1 using a pre-allocated username and earlier selected password. System 1 then serves up a specific media interface for providing a suite of reports and substantially real time statistics and details for the event. This interface also allows for custom queries to be run by representative 111. In some embodiments organiser 49 offers exclusive access to representative 111, while in other embodiments a number of different representative from different media outlets are pre-enrolled.

In further embodiments, organiser 49 generates “live reports” or “live updates” via system 1 and has those uploaded to a website, or included in social media pages, or otherwise electronically disseminated, to raise awareness of the event and its status and progress.

System 1 is also advantageously configured not just to allow position data or other timing data to be provided to the participants, but to facilitate the overall operation of the event, from enrollment, to the running of the race, and to the analysis of the event both for individual participants and for the operation of the event subsequently. For example, in this specific embodiment, the enrolled participants are able to download their respective historical location data and the associated timestamps) to gain a record of their performance along path 4. This historical location data is able to be downloaded, for example, with a web enabled devices such as a smartphone 115 (individually shown as samrtphones 115a, 115b, . . . , 115n) running a local app that allows the extracting of performance parameters from the downloaded data. This functionality is also able to be supplemented with a playback feature that provides an indication the relative progress against other participants in the same group. That relative performance could be more generically presented (that is, depersonalised) in terms of being relative to only the average for the group, or the extremes for the group, for example.

The preferred embodiments of the invention make use of a wearable tracking device for allowing an individual participant to gain an effective real time indication of his or her position in a race. The real time nature is contextual to the event or race, such that it is effectively real time (rather than being actually real time) when viewed from the perspective of the participant, followers of the participant, an event organiser or other users of the position data that is generated by the preferred embodiments. In the above embodiments the real time indication is provided continuously, or effectively continuously, as the user progresses along path 4. In other embodiments, the real time indication is provided intermittently or periodically. In further embodiments the real time indication is provided only at predetermined points along path 4.

The form of the wearable tracking device is similar to that of a small wristband device (much like a watch) that is packaged in a robust, waterproof and reusable housing, and which makes use of a rechargeable battery. The preferred device has a small visual display to provide the participant with the position data, or data derived from the position data. This position data includes, by way of example, the position of the participant relative to the path being followed, and the relative position of the participant to other participants.

The overall system provided by the preferred embodiments updates the position data on a regular basis and communicates the updated data to the participants (that is, to devices 10) to ensure delivery of the updates in close to real time. Accordingly, throughout an event the participants will obtain regular feedback about their respective positions and/or about other timing characteristics relevant to the participants. While the system described above focuses primarily on the participants, a further feature of the system is the ability to provide frequently updated position data for all participants to other users of the system. For example, to inform spectators and event organisers on the progress of each participant, or to provide alerts about participants with possible problems.

Accordingly, the system of the preferred embodiments provides to a plurality of users in a group of users an indication of respective positions of the users relative to one or more of the other users in the group. The system includes:
a plurality of wearable devices for wearing by the respective users in the group, the wearable devices each including:
   (a) a transceiver for: receiving a first signal containing position data that is indicative of the position of the respective user relative to at least one of the other users; and transmitting a second signal containing current location data that is indicative of the current location of the device;
   (b) a location module for generating the current location data;
   (c) a processor that is responsive to: the position data for generating a fourth signal; and the current location data for generating the second signal; and
   (d) an interface that is responsive to the fourth signal for visually displaying to the respective user an indication of the position of the respective user relative to at least one of the other users;
a first database for containing historical location data for the users; and
a processing station for accessing the first database and being responsive selectively to: the historical location data for generating the position data; and the current location data for updating the historical location data.

In some embodiments devices 10 regularly update and broadcast the current location data (that is, regularly transmit signal 60) which is received at one of stations 9 and then transmitted to system 36 to allow processor 37 to calculate updated position data for subsequent transmission. In other embodiments, devices 10, while regularly updating the current location data, only transmit that upon request by one of stations 9. In still further embodiments, devices 10 record a sequence of current location data and have these batch transmitted to one or stations 9, either automatically or upon request.

In system 1, devices 10 include a single form. In other embodiments the form is segmented and worn in spaced apart locations on the participant. For example, in one such embodiment the GPS module 65 is separate from, and communicates wireless with, the remainder of device 10. The segments are releasably attached to respective wrists of the participant.

One of the key characteristics of the design and configuration of system 1 is to provide scalability in practice. That is, to allow system 1 to be easily and cost-effectively deployed along a short course having only one or a few stations 9, or along a longer course having many hundreds of stations 9, or along those courses falling between the first two. This scalability also goes to the numbers of competitors in the event being held, which could be a very small number such as ten or less, up to a very large number in the order of one hundred thousand or more. That being so, for enabling communication directly with the wearable devices the inventors have been biased away from the use of mobile data network technology and any other communications technologies that depend on acknowledgements/retries. This bias is due to recognising the bandwidth limitations of such technologies, and the latency problems that arise for large numbers of competitors in an event. To provide for as wide as possible application of a single technological solution, the inventors selected for the preferred embodiment the use of broadcast/best-effort communications. More particularly, the system has been configured to operate in an ISM band and, where required, to use multiple channels for different types of services/communication and to allow for load sharing and/or latency minimization. Using this design characteristic the preferred stations 9 include:
The ability to send and receive data from the individual devices 10 using a broadcast transmission in at least one direction, and preferably both directions.
An onboard power source, such as a battery.
An interface for allowing the use of a mobile data network as backhaul. That is, making use of a broadcast channel or channels to communicate with the multiple devices (at varying locations) allows for a high rate of acquisition/transmission of data directly to and from devices 10. However, the transmission between system 36 and stations 9 (which, compared with devices 10, are much fewer in number) is able to be effectively achieved using unicast communications. That is, broadcast transmission is used for part of the communication, and non-broadcast transmission is used for another part of the communication.
The ability to support spacing between adjacent stations in the order of 1 km or more (although actual spacing will depend on geography of the route or path being followed by the competitors).
Different wireless channels for allocation to different purposes/services.
At least two broadcast channels to broadcast the current runner order to devices 10. The first service is a standard services that operates at a first update rate and the second service being a priority/premium service that operates at a second update rate that is greater than the first update rate.
Multiple transceivers to allow simultaneous use of multiple channels.

It will be appreciated that, in use, system 36 will be receiving an almost continuous stream of current location data (and the associated timestamps) from devices 10. This current location data will be stored in database 5 and will now be part of the historical location data. Processor 37 is responsive to the most recent historical location data for all participants 2 for periodically (or otherwise) calculating the most recent position data those participants. This position data is then broadcast such that individual devices 10 are able to receive the most recent position data for the respective participant 2.

The rate at which the most recent position data is calculated by processor 37 is, as a general rule, dependent upon the system speed, as well as the total number of participants. In some embodiments the participants are provided the option of faster rates of update. In still further embodiments, categories of participants—for example, professional athletes or elite athletes—are provided faster rates of update than is available for other participants.

Also in accordance with the key characteristic of the design of system 1, devices 10 obtain an indication of their location (that is, obtain current location information) on a regular basis and transmit wirelessly that current location information to at least one of stations 9. The transmission is preferentially short to minimise bandwidth and latency implications. In practice not all of the transmissions will be received due to collisions. To reduce the impact of this factor, stations 9 use spectrum management and system 1 as a whole is configured for a high frequency of updates. Furthermore, devices 10, typically before being issued to the respective participants, are supplied with a digitised form of the route in the form of the coordinates of a sequence of waypoints. This allows devices 10 to generate current location information other than as GPS coordinates. More particularly, devices 10 are able to generate current location information in a form which identifies a waypoint and a distance from that waypoint. This allows use of a data format such as [waypoint #, distance]. For example, [59, −10] to indicate that the participant 2a is on path 4 at ten metres past waypoint #59. This format reduces the size of the current location data and hence contributes to an improved overall speed for system 1. The use of waypoints in devices 10 provides the devices themselves with the details of path 4 and they are able, therefore, to determine how far each participant is along path 4. This facilitates a reduction in the amount of data needed to broadcast to stations 9 as a distance is able to be sent instead of a much longer GPS coordinate. This factor allows system 1 to support a large number of devices 10—that is, it contributes to the scalability of system 1—while still providing effective real time communication of the required timing data.

Referring to FIG. 2 it is again mentioned that participants 2 all typically pass start line 21 and finish line 22. The times at which those individual participants pass those lines is particularly significant, and perhaps more so than when passing any other waypoint on path 4. While devices 10 have a GPS module 65, which is available to determine when line 21 and 22 are crossed (assuming device 10 has been pre-loaded with a definition for start line 21 and finish line 22), the available precision is not deemed sufficient for a number of applications. In recognition of this, and in an attempt to provide a single technological solution for a broader range of applications of the preferred embodiment, the inventors have developed an alternative approach. More particularly, system 1 involves having each participant, upon enrollment, issued with a prior art small RFID tag that is usually attached to an item of clothing or a wrapped around the wrist or ankle of that participant. In addition, two interrogation mats are respectively placed across start line 21 and finish line 22 to interrogate the RFID tag as the participant crosses the start line and finish lines respectively, and to assign a timestamp to those interrogations. This provides a relatively high degree of precision of the line crossing event, which is dictated by the width of the mats. It is noted that even with the use of such mats not all the tags will be correctly interrogated all the time, which results in incomplete and/or inaccurate location data. In the presently preferred embodiment, device 10 is pre-programmed with the location of line 21 and 22 and is pre-programmed to provide respective timestamped current location data when device 10 is assessed to be at those locations. Accordingly, in the event the RFID tag is not correctly interrogated by mat 121 or mat 122 the relevant location data in record 27 or 28 (as the case may be) is populated with the timestamp data from device 10. That is, the best available data is used to populate record 6a to provide the best available timing precision at lines 21 and 22 while still accommodating high competitor numbers.

In other embodiments different timing arrangements are used at lines 21 and 22. For example, in some embodiments use is made of a highly localised and/or highly directional RF signal that is detected by devices 10 to determine the moment lines 21 and 22 is crossed by devices 10.

The following table provides an indication of the operation of system 1 when used for an event involving 10,000 competitors and making use of 1,000 waypoints. The column entitled “Expected Performance” is the time for the function referred to in the first column to be refreshed using the most current position data.

| | Estimated | | | |
|---|---|---|---|---|
| | data | Calculation | Expected | |
| Function | volume | Assumptions | Performance | Units |
| | packet | | | |
| | (60 bytes) | | | |
| Device | 7 byte | 10,000 | 325 | seconds |
| location | broadcast | competitors | | (to receive |
| | packet | spread over | | all location |
| | | 4 channels | | data |
| | | | | from all |
| | | | | participants) |
| Start time | 12 byte | | 1 packet = | |
| monitoring | broadcast | | 13 ms | |
| | packet | | | |
| Finish time | 12 byte | | 1 packet = | |
| monitoring | broadcast | | 13 ms | |
| | packet | | | |
| Race position | 7 bytes per | 10,000 | 16.68 | Seconds |
| advertisement | participant, | competitors | | |
| | 9 participants | | | |
| | per packet | | | |

While packets with less than 64 bytes of current location data or position data should be transmitted in less than 15 ms, this higher figure has been used in the above table to provide a conservative overview of the operation of system 1.

In other embodiments the functions of device 10a are performed wholly or partly by a different wearable device that need not be issued by the operator of system 1. Such a different device is able to belong to participant 2a. For example, in one such embodiment participant 2a has a third party GPS Smart Sport Watch to provide the participant with access to all standard GPS Smart Sport Watch features, such as altitude, speed, time, etc. The location data is generated from this Sport Watch and communicated to stations 9 either directly (where the Sports Watch supports such broadcast communications) or indirectly via a transmitter (packaged similarly to device 10a, although with no display) which is issued to participant 2a by the operator of system 1. Moreover, the position data, or other timing data, generated by system 1, is likewise able to be communicated to the Sports Watch to enhance the data and analysis available to participant 2a.

Based upon the above it will be appreciated that while in the first described embodiment of device 10a the components for communicating with stations 9 and the location module were located within a common housing, in other embodiments those functional blocks are located in separate housings and communicate with each other, for example, by the Bluetooth protocol. In some such embodiments an existing third party manufactured and supplied Sports Watch (or similar device) is supplied to the participant with an app or other such locally executable code for facilitating communication between the Sports Watch and system 1. Moreover, such code is able to allow relevant data 6 to be downloaded to the Watch. In other such embodiments the third party Sports Watch includes dedicated hardware (one or more chips), whether proprietary or otherwise, for enabling communications with system 1.

It will also be appreciated that data 6, for a given participant, is able to be downloaded (either as is or with appropriate re-formatting) to a device running one or more third party apps such as a health and/or fitness app.

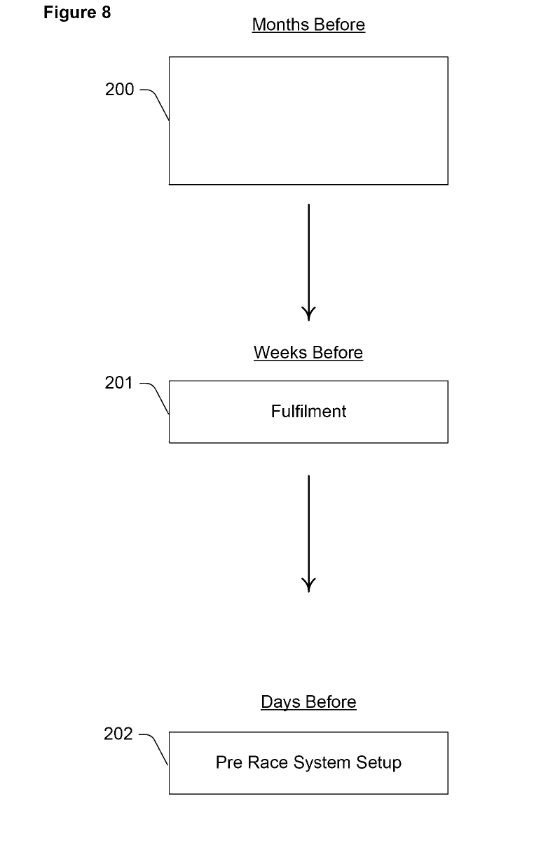

In use, operator 49 will request the operator of system 1 to supply the timing services for an event. This will include specifying the event in terms of the course (that is, the location, length and other characteristics of the path), the anticipated number of competitors/participants, the anticipated duration of the event, the required position data or other timing data that is to be communicated, the enrollment process, data rights/sharing, fulfilment timelines, other legal issues, responsibility for logistics rollout, and consideration and other contractual matters. Once those and any other required preliminary issues are resolved between the parties the required hardware is able to be selected to allow the configuring of a suitable system 1 to provide the desire functions and performance. A typical sequential sequence of steps adopted for the operation of system 1 is illustrate in FIG. 7, which includes:
Step 130: Device registration (allocation of device to individual competitors/participants).
Step 131: Pre-event status.
Step 132: Event start status (participant crosses start line 21).
Step 133: Event underway.
Step 134: Event end status (competitor crosses finish line 22).
Step 135: Device de-registration.
Steps 130 and 131 are shown in more detail in FIG. 8, where the initial set up of database 5 and the establishment of interface 39 occurs well in advance of the event to allow time for the potential participants to become aware of the event and enroll online. This online enrollment will require the participants to each enter sufficient details to allow their respective identifies to be understood and to obtain sufficient contract details to allow later mailing or onsite collection of devices 10 and electronic communications. When enrolling each participant, if he or she has not already done so, will have a personal account created having a unique user name and password. Through the medium of this account the participant is able to specify an association with a group of other participants, the willingness to share some or all of the data 6 for that participant with one or more other participants or followers, and other such access rights. As a default the account will not allow a participant access to data for any other participant. If a given participant selects the option to share his or her data, system 1 seeks confirmation of this prior to granting such access to the other participants or followers. It will be appreciated that typically organiser 49 and the operator of system 1 have full access to all the data for generating reports, commentary, statistics, media releases, and other such analysis,

With the participants enrolled it is possible to mail out devices 10, or have the devices collected at physical locations in the days leading up to or on the day of the event itself. For those events where RFID tags are also used, those tags are typically packaged together with respective devices 10 and any instructions about the use and required registration of devices 10 and the tags on the race day or on the days prior to the race day.

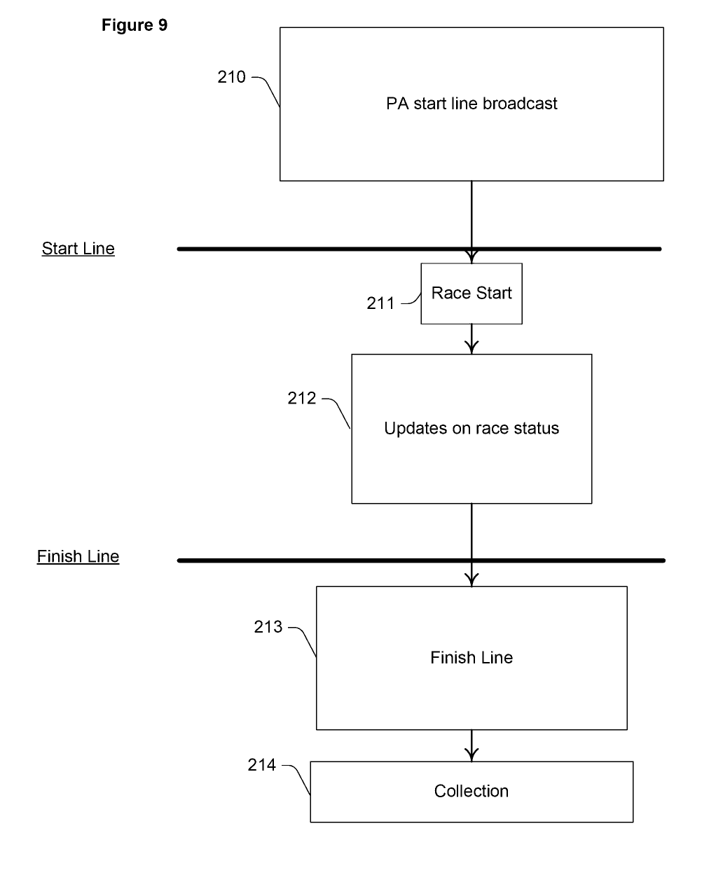

In this embodiment the enrolled participants collect respective devices 10 from a collection tent (provided by organiser 49) when physically entering the event. This is shown as a further part of step 131 and is illustrated at the top of FIG. 9. The devices 10 are, just prior to being given to the participants, registered to be associated with that participant to allow for the accurate storage of the subsequently obtained location information within database 5. The collection point for devices 10 is within a broadcast area of at least one of stations 9 and, upon issue to the participants, the devices 10 provide an initiation broadcast with a range of data. System 1 is responsive to this initiation broadcast for finalising the registration of device 10 and for downloading to that device set-up data. This set-up data includes, for example, a digital map of path 4, any preliminary or stored messages to the participant from followers or organiser 49, confirmation of details for participant 2, and other such data. This set-up occurs within a matter of seconds and, as such, it is possible to quickly identify any faulty devices 10 and for those to be replaced, or for the participant to be listed for compensation.

A final part of step 131 is for system 1 to initiate a broadcast to all devices 10 to provide a five minute alert to the official commencement of the event. In other embodiments an alert is provided at additional or different times from the official start of the event.

Once the event has officially commenced system 1 ensures this is broadcast to all devices 10. Shortly after, a number of participants will pass over line 21 and the operation of system 1 moves to step 132 which is, together with steps 133 and 134, also shown in FIG. 9.

As the event progresses system 1 receives regular and frequent current location data from each of the participants and is responsive to this data to update the historical location data 6 in database 5. Moreover, system 1 is responsive to the historical location data 6 for regularly and frequently generating timing data (such as position data) and having that timing data broadcast from stations 9 and communicated to devices 10. Accordingly, each participant 2 receives tailored timing data that is regularly updated to provide, in effect, real time feedback during the event. It is also important to note that in addition to the in event usage of the location data, participants 2 are able to access the historical location data 6 post event.

Once the participants 2 cross line 22 they each remove the respective devices 10 and have them placed in collection bins or other receptacles. Once so placed, devices 10 provide a final upload to system 1 of any outstanding data, and shutdown. In the event that one or more of the participants forget to remove the device it will continue to operate and provide current location data to system 1 Accordingly, the relevant participants will be provided with an alert that is sent to device 10, and event personnel will be provided to a web enabled handset) the location of the relevant devices 10. This facilitates the more complete collection of the devices for cleaning and then reuse. Moreover, devices 10 in this embodiment have waterproof housings and are configured for wireless recharging of the batteries within those housings. This allows for ease of mass handling of the devices between events.

The above operational steps are provided as an example only, and there is considerable flexibility for system 1 to be configured to operate differently to accommodate the needs of different events and/or parties involved in the organization and implementation of such events.

In summary, FIG. 8 illustrates three successive stages 200, 201 and 202. Stage 200 includes the following actions occurring the months leading up to the event:
System 1 operator provides a registration API.
API is plugged into the website of the organiser 49.
Database 5 is established.
Interface 39 is created.
Organiser 49 alerts potential participants to register online via its website.

Stage 201, the fulfilment stage, includes the following actions occurring the weeks leading up to the event:
The base station layout is determined,
The devices 10 are mailed to participants.
The availability of collection tents/bins for the devices is ascertained.
Additional information is provided by email to the participants.,

Stage 202, the pre race system setup stage, includes the following actions the days before the event:
Stations 9 are installed along the course,
Stations 9 and devices 10 are subject to automated pre-event checks.
The start/finish equipment (the RFID sensors) are deployed.
The bins are placed for the post-event collection of devices 10.

In summary, FIG. 9 illustrates five stages, being a start line broadcast stage 210, a race start stage 211, a race status update stage 212, a finish line stage 213 and a collection stage 214. Stage 210 includes the following actions occurring:
Providing supplementary base stations for registration.
Compensation for failed devices. For example, a refund or an upgrade being provided to the relevant participant of participants.
An alert sent to devices 10 that it is five minutes from the stark of the event.
An alert sent to devices 10 that it is two minutes from the start of the event.

Stage 212 includes the following actions occurring:
Technicians being available for support during the race
Rapid replacement of any detected faulty stations 9.
Safety and emergency staff staged along the course;.
Updates provided on the race status, including commentary, safety and media feeds/

Stage 213 includes the following actions occurring:
Device 10 records finishing data and no longer updates.
Results data sent to competitor and authorised followers.

Stage 214 includes the following actions occurring:
The availability of collection bins for the collection of devices 10.
Operator staff available to assist if post race support is required.

In another embodiment base stations 9 are omitted as devices 10 make use of LTE-M standard (that is, LTE for machine-to-machine communications) rather than the 900 MHz GFSK radio link referred to in the above preferred embodiments. That is, devices 10 obtain the GPS data in the same manner, but experience two-way communication with station 7 directly via one or more mobile telecommunications towers in the vicinity of path 4.

This configuration allows users to receive real time updates at most if not all points along path 4. The main difference over the earlier embodiments is the omission of stations 9 to facilitate communication to and from devices 10. This embodiment is particularly useful where the LTE standard is available, and the anticipated bandwidth is sufficient to accommodate the likely requirements for the event. For particularly large events, for example, use is able to be made of both stations 9 and the LTE standard of communication to supplement or complement each other. For example, if some points of the course have lesser LIE bandwidth, then, it is possible to supplement that with one or more appropriately located stations 9. If there is a desire to increase the accuracy of the timing (for one or more or all of the participants), then both forms of communication are able to be used to provide for error checking.

As presently envisaged, the use of the LTE standard in the above embodiment allows the devices 10 to be designed to have: a longer battery life; lower device cost: lower deployment cost (due in part to the elimination or reduction of the number of base stations); better coverage from an existing public mobile telecommunications network; and better support for large numbers of users in a single event.

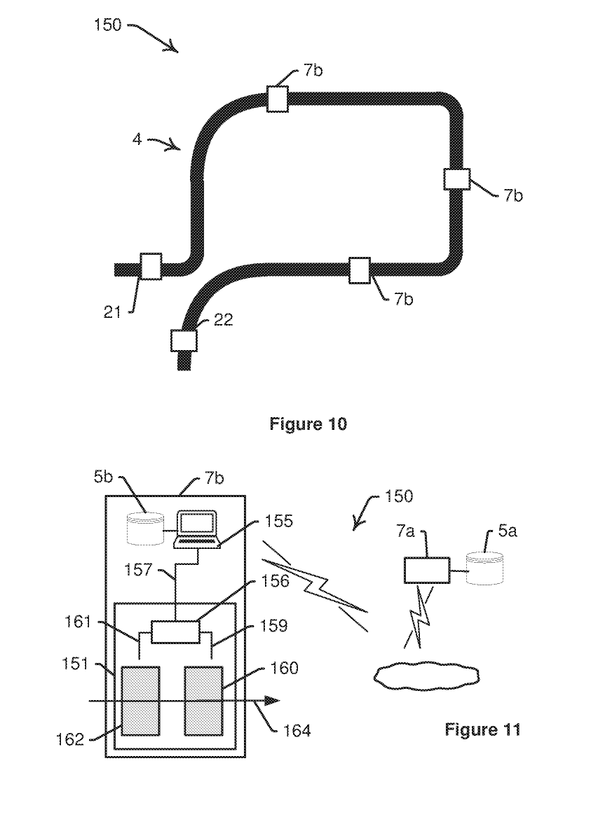

Reference is now made to FIGS. 10 and 11, which illustrate schematically a further embodiment of the invention and where corresponding features are denoted by corresponding reference numerals. A number of the features described in the above embodiments have been omitted for the sake of clarity and simplicity, and to prevent unnecessary repetition. In particular, FIGS. 10 and 11 collectively illustrate a system 150 for providing to participants 2 with an indication of respective positions of the participants 2 relative to one or more of the other participants. As with the FIG. 3 embodiment, system 150 includes a first database 5a which is remote from path 4. This database stores historical location data 6 for each of participants 2. However, in this embodiment, database 5a is segmented and includes also remote databases 5b (only one shown by way of example in FIG. 11). Data 6 is stored collectively in databases 5a and 5b. which will be described in more detail below. System 150 also includes a processing station that is distributed and which includes a central processing station 7a that is typically located remote from path 4, and distributed processing stations 7b that are spaced apart along or adjacent to path 4 between line 21 and 22. In some embodiments, processing station 7a is omitted, or not actively communicating with stations 7b during the event. In other embodiments stations 7a and 7b are actively communicating during the event.

While only stations 7b are explicitly illustrated it will be appreciated that different numbers of stations are able to be deployed. For example, in one embodiment the number of stations 7b deployed is such that there is no more than one kilometre between successive stations along path 4.

The processing station also includes a plurality of temporary base stations 151 that are part of respective processing stations 7b.

One of stations 7b and the associated station 151 is illustrated in more detail in FIG. 11. In particular, station 7b includes a computing device, in the form of a laptop computer 155 that is able to selectively access database 5b. In other embodiments the computing device is a desktop computer, or other hardware and software combinations for performing the required functionality.

The database 5b contains that part of the historical data 6 that has been collected at this station 7b for this event. That is, data 6 in this database 5b will include location and timing data for each of the participants 2, once those participants have passed by station 7b. Station 101 includes an interface provided by hardware 156 that, receiving the first signal from station 7b and which also provides the second signal to station 7b, both of which are transmitted along cable 157. The first signal is derived from the location data for the group of members stored in database 5a, Hardware 156 includes a transceiver (not explicitly shown) having a first antenna 159 for establishing a first transmission field 160 for wirelessly transmitting by a Bluetooth protocol the first signal to the wearable device 10 of the user when that device is in field 160.

The transceiver also has a second antenna 161 for establishing a second transmission field 162 that is adjacent, and upstream along path 4, to field 160. The transceiver wirelessly receives by a Bluetooth protocol a third signal from device 10 that, when device 10 is in field 162, is indicative of the location of the user.

Laptop 155 is responsive to the third signal for generating the second signal.

Antennas 159 and 161 are, in this embodiment, each sandwiched between two opposed and overlying rubberized rectangular layers to define collectively a radiating mat. These two mats are placed along path 4 such that the runners pass over them sequentially. The fields 160 and 162 extend upwardly from the respective mats by about two metres. Accordingly, the mats are placed about two metres apart, in the direction of travel along path 4, to prevent interference between the fields.

In use, database 5a is prepopulated with data indicative of the devices 10 being used in the event (typically in the form of a device ID), and the identity of the participants 2 allocated to those respective devices, and any groupings of the participants. Those grouping can include, for example, a category such as “Female, age 24-29”, or a category including predetermined participants who collectively enrolled as a group to compete against each other. It is also able to include data indicative of a “rival” against who the user is wishing to assess his or her progress during the event. The rival is able to be another participant in the event, a participant in an earlier event along path 4 (being the user himself or herself, or another person) or a virtual rival that is constructed with predetermined characteristics such as total time to complete the event, split times, varying or constant speeds, fatigue options and the like. These characteristics are able to be set, in automatically in accordance with a rules engine based upon historical data for a user, or is able to be set by a coach of the user, or the user himself or herself.

As the lead runner in the event travels along path 4 in the direction of arrow 164, he or she will enter field 162. Device 10 is responsive to the field 162, and the interrogation signal transmitted, for issuing generating the third signal which includes an identifier. In this embodiment, device 10 does not generate any specific location data or timing data and, as such, does not require an on-board location device. Rather, that location data is implied or inferred from the fact, and the timing, of the presence of device 10 within field 162. It will be appreciated that with the use of short or near range wireless fields, such as those provided by a Bluetooth protocol, it is possible to have a well-defined field and, hence, to generate sufficiently well-defined location information and timing information for a large public event.

The transceiver extracts the identifier, or data indicative of the identifier, from the third signal and supplies this to laptop 155. In turn, laptop 155 runs software instructions for storing in database 5a the data 6 that is indicative of the location of station 7b (or simply an identifier for station 7a), the identifier, and a timestamp. Laptop 155 is also responsive to the software instructions to ascertain which, if any, of the participants have already arrived at field 162 of station 7b for that event and to apply a corresponding ranking to data 6 for the runner. As this participant is the first to arrive, the ranking applied will be “1”. As the runner continues along path 4, continuing in the direction of arrow 164, he or she will leave field 162 and enter field 160. Once that occurs, device 10 will be interrogated by field 160 and will again provide its identifier, which the transceiver conveys to computer 155. In response, computer 155 access database 5a. In doing so, it will be ascertained that the rank of the runner is “1” and the second signal will be generated accordingly. It will be appreciated that additional information, rather than just the rank of the runner in the race, is able to be determined at this point and corresponding, additional data included in the second signal.

The transceiver is responsive to the second signal for transmitting the required data to device 10 while still in field 160. Accordingly, device 10 is then able to provide the runner with his or her ranking in the event.

As further runners pass sequentially through fields 162 and 160, they too will receive an accurate indication of their respective rankings.

Other often provided information to the runners at station 7a includes, in addition to the overall ranking referred to above, the ranking within a predefined group of runners, the time ahead/behind a predetermined rival, the distance covered along path 4, and the distance remaining to be covered along path 4. However, it will be appreciated by those skilled in the art that other information is also able to be provided.

It will be noted that laptop 155 includes a communication link, via a standard telecommunications network, with station 7a. This allows for the communication of data between the stations. However, in this embodiment, that data is limited to messaging for those manning station 7b, and to communicate administrative information about the operation and status of the event. Most of the historical data 6 is not communicated but, rather, remains stored on individual databases 5b. Once the event is completed, the segmented databases 5b are brought to a central location and the segmented data 6 uploaded via a high speed physical connection to define a common source of that data. Accordingly, within a short time of the event being completed, each participant will be able to access his or her own data, typically via a password protected website provided by the event organiser.

In other embodiments, database 5a is a cloud-based database and laptop 155 communicates with that database wirelessly.

Preferably, use is made in system 150 of devices 10 that are issued by the race organiser. However, system 150 is also able to accommodate other wearable devices such as a third party smart watch.

As all device 10 is required to transmit is a device ID (or other identifier) that device is able to be simplified and power consumption reduced further. This more passive nature of the devices 10 allows for better cost containment in their manufacture and construction, while also contributing to a longer battery life (with all else being equal).

While in the FIGS. 10 and 11 embodiment described above the wearable device is a single wrist mounted device such as device 10a, in other embodiments, use is made of two wearable devices. For example, in one such embodiment, a first wearable device generates the third signal and a second wearable device receives the first signal and display to the user his or her ranking and other “in race” or real time information relevant to the user. Preferentially, the first wearable device and the second wearable device are, in use, spaced apart on the user and include respective fastening means for affecting their fastening to the body of the user. In one specific example, the first wearable device and the second wearable device are respectively a passive RFID device (not shown) sewn into a racer bib issued by the event organiser and the display device 10. As the RFID device is providing the third signal, device 10 is configured (via a software control) not to perform that function for the given event. In some embodiments device 10 is substituted with a simpler display device which, although similar to device 10, does not have the ability to provide or selectively provide the third signal. Where use is made of such an RFID device, field 162 is an interrogation field configured for interrogating the RFID devices as the respective users cross the mat that is across path 4. Accordingly, fields 160 and 162 are able to use different protocols or standards for communication with the second and the first wearable devices respectively.

In another embodiment, the second wearable device is a smart watch or a smart phone carried by the user.

In other embodiments, the first wearable device takes other forms. For example, the first wearable device is, in some embodiments, a UHF device or other short-range wireless device. Moreover, in other embodiments the first wearable device is located other than in the bib. For example, in some embodiments the first wearable device is attached to a shoe or another of the user's garments. In further embodiments the first wearable device is, in use, attached to the user's body by a bracelet or anklet.

Moreover, system 150 also accommodates the relatively small subset of runners that wish to use their own smart watch and smart phone combination. That is, the smart phone interacts with the two fields 160 and 162, and also uses a Bluetooth protocol (or equivalent) to relay the required information to the smart watch to display the rank for the runner, and any other data obtained.

In other embodiments, fields 160 and 162 are a single field that extends along path 4 for a sufficient distance to allow for both the initial interrogation of device 10, the required processing by laptop 155, and the subsequent supply of the first signal to device 10.

Systems 1 and 150 collect, timing and location data to provide a real time indication of the ranking (and other information) to the user via a wearable device. These systems are also able to be responsive to the data to drive one or more public displays for displaying selectively that information. For example, in some embodiments of system 150 there are provided large portable LED displays for displaying to the users as they emerge from each of station 7a the name of the user and the absolute ranking in the event. In other embodiments, such a display is provided in clear view of major spectator areas. It will be appreciated by those skilled in the art that many other locations for such displays are possible.

All the above-described embodiments allow for personal ranking data (relative to overall, category, rival) to be provided to the user while “on course” (that is, during the event) in substantially real time.

The major advantages of the above embodiments include:

Users (that is, the athletes themselves) are provided with real time position data. This is able to be one or more of the overall position in an event and/or the position within a category of participants in the event.

Users are provided with real time information about how far ahead or behind a given rival is.

Followers (typically supporters of the user) are able to communicate messages to the user. This is particularly advantageous when the two are out of eyesight/ear shot, and can be enabled by the followers using a smartphone, cellular telephone, computer, or a web-enabled device to send a message. Example forms of the message include those generated by an email, SMS, an instant messaging service, the update a dedicated social media site, or the like. In one present embodiment the followers send messages to system 1 through a mobile app (that is, by the follower using respective smartphones having a resident app) or SMS and those received messages are forwarded on through system 1 to the competitor's wearable device. That is, system 1 makes use of the mobile data network to communicate with stations 9 and then the 900 MHz network to communicate with devices 10.

Followers are able to locate a user on the course.

Followers such as race event organisers gain real time position data for all the participants to facilitate commentary, and to automate the drive to HDTV displays and media feeds.

Facilitating the race organisers identify and/or locate athletes on the course that require medical attention.

Providing athletes with a detailed post-race analysis of performance, including relativity to other runners, or a category of other runners.

Providing athletes prior race tracking relativity when racing the same course at a different time, whether in or out of race conditions. This also includes the ability to complete a known course in a virtual capacity.

The ability to more accurately forecast race finish times.

Easy race participation registration.

The real time estimated time of arrival (ETAs) of athletes at different checkpoints on the course to allow spectators to ‘meet’ a specific athlete in-race.

ETA of athlete race finishing time.

SMS result alerts post race.

Full post race data download and interrogation for athletes, event organisers and followers (including detailed ‘positional’ simulated video replay).

The ability to overlay performance from a prior race onto the wearable device for the same race/racecourse next year. This enables the athlete to race themselves by tracking his or her performance in the future race against their ‘old self’, in real time.

The ability for the event organiser to deploy safety interventions in the event athletes have not been moving for a specified period of time.

The ability to download race event information to third party fitness apps.

The ability to deploy a standalone wearable device that enables a virtual race. That is, the ability for a user to run a racecourse, outside of a race day, and track how he or she would have been positioned in the field as they move through the course. This being ideal for race preparation, familiarization, visualization and strategy.

It enables website competitions and prizes for participants and others. For example, by pooling athlete results to show whom has the fastest 10 km time or highest average positions across grouped races. This encourages a sense of camaraderie and healthy competition amongst groups, which is particularly useful in larger public events. This can also apply to creating an online community of racers across different geographies, e.g. racers in Europe comparing and competing in a virtual sense with racers in America.

The ability to synchronise an athlete's position with geographical markers and, in turn, provide commentary (via headphones or the like) of the environment as the athlete passes through it.

Allowing integration with a GPS Smart Sport Watch to provide the participant with access to all standard GPS Smart Sport Watch features, such as altitude, speed, time, etc. That is, the participants own GPS Smart Sport Watch is able, upon appropriate configuration, to substitute for the wrist worn device to provide the close to real time tracking of the relative position of the participant as well as all the usual functionalities of the watch.

The provision of varied update frequencies to the athletes base on the radio transmission, frequency used.

An enhanced understanding of the race environment for athletes, spectators and event organisers.

Not limited to provide start and stop times, split times, or race duration, and is open to providing many other forms of data. Moreover, this data is able to be sent in real time to the athlete, the event organiser and supporters etc.

Increased spectator engagement, attendance, and connection with the athlete he or she is following. This occurs through having better information about the location of the athlete, but also due to being able to send messages to the athlete.

The ability for the athlete to make more informed decisions during the event. Most athletes compete in athletic races (for example, marathons, triathlons, cycling races etc.) to race. That is, there is an intention to compete against each other. Public participation events and many elite events are so large in participant numbers and over such a distance, that unless an athlete is in the lead or within three or four positions of the lead, they have no accurate way of automatically and consistently obtaining, at any point in time, what, their relative race position is. The preferred embodiments greatly ameliorate this downside of the prior art.

The ability for race event organisers to confirm whether an unscrupulous participant has varied from the path by, for example, taking a short cut. The continuous stream of GPS data will reveal the actual path taken by the participants.

The ability to interconnect with and leverage from existing timing hardware and software to offer more accuracy and/or additional functionality during and after the event.

The ability to combine two different communications systems to complement each other to provide the required functionality, or supplement each other to provide additional accuracy.

Accommodates both dedicated wearable devices issued by the event organiser, or third party devices more typically owned by the user. For example, it accommodates:
i) Sending data to a smart phone for relaying to a smart watch or custom device.
ii) Sending information to an existing or custom ‘chip’ won by the user, then sending this information to a device with a visual display.
iii) Sending information directly to a device with a visual display (dedicated device or third party device),

Able to be adapted to communicate to and from third party devices via proprietary or more generic Application Programing Interfaces (APIs),

Being able to send the ranking and other data for the user to one or more of a wide range of custom or third party devices. This includes the ability to format the data such that it is easily recognised by the user during the event without creating a dangerous distraction. Examples of available delivery platforms for the data include:
i) Smart phone (third party or custom).
ii) Smart watch (third party or custom).
iii) Heads up display (third party or custom).
iv) Audio feed (third party or custom).
v) Electronic display on the clothes or elsewhere on the user (third party or custom).

The ability to: time and cost-effectively collect and process incoming data from wearable devices on users during an event being undertaken by those users; manipulate this data to derive one or more particularly useful distilled measures; and communicate this or those distilled measures to the users in a timeframe that ensures the measures have currency,

### Conclusions and Interpretation

It will be appreciated that the disclosure above provides various significant systems and methods for providing a user with timing data indicative of one or more characteristics of the user's progression along a predetermined path and systems and methods for providing to a plurality of users in a group of users with an indication of respective positions of the users relative to one or more of the other users in the group.

Unless specifically stated otherwise, as apparent from the following discussions, it is appreciated that throughout the specification discussions utilising terms such as “processing,” “computing,” “calculating,” “determining”, analysing” or the like, refer to the action and/or processes of a computer or computing system, or similar electronic computing devices, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” or a “server” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network, or may be implemented as a cloud computing system. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, a vibration alert system and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-read able carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance a network router, a smart phone, a switch or bridge, or any machine capable of executing a set of instructions (sequential or otherwise) that specify actions to be taken by that machine.

Note that while diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

It should be appreciated that in the above description of exemplary embodiments of the invention, various features of the invention are sometimes grouped together in a single embodiment, Figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not, other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention,

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not, in direct contact with each other but yet still co-operate or interact, with each other.

Thus, while there has been described what are believed to be the preferred embodiments of the invention, those skilled in the art will recognize that other and further modifications may be made thereto without departing from the spirit of the invention, and it, is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1-15. (canceled)

16. A system for providing to a plurality of users in a group of users with an indication of respective positions of the users relative to one or more of the other users in the group, the system including:
a first database for containing location data for the users;
a processing station for accessing the first database and being responsive selectively to the location data for generating first signals; and
a plurality of wearable devices for wearing by the respective users in the group, the wearable devices each including:
(a) a receiver for receiving the first signal;
(b) a processor for processing the first signal to generate a second signal; and
(c) an interface that is responsive to the second signal for visually displaying to the respective user the indication of the position of the user relative to one or more of the other users in the group.

17. A system according to claim 16 wherein the users are simultaneously progressing along a predetermined path having a start and an end and the indication of the respective positions of the users relative to one or more of the other users in the group is a substantially real time indication of one or more of:
a ranking of the respective users relative to one or more of the other users in terms of progress along the path;
an indication of the time interval along the path between the respective users and one or more of the other users;
an indication of the distance along the path between the respective users and one or more of the other users;
an indication of the distance between the respective users and one or more of the start and the end;
an indication of the respective time of arrival of the users at the end;
a rate of progress of the respective users relative to the rate of progress of any one or more of the other users; and
a required rate of progress of the respective users relative to the rate of progress of any one or more of the other users.

18. A system according to claim 16 wherein the processing station includes a plurality of spaced apart base stations for wirelessly transmitting the first signals and for receiving wirelessly third signals from the wearable devices.

19. A system according to claim 18 wherein the wearable devices each include a location device for providing current location data for the respective devices and the processor is responsive to the current location data for generating the third signals.

20. A system according to claim 19 wherein the receivers are transceivers and transmit the third signals.

21. A system according to claim 18 wherein the processing station is responsive to the third signal for updating the location data.

22. A system according to claim 19 wherein the location devices derive the current location data from one or more of:
one or more GPS signals;
triangulation; and
multilateration.

23. A system according to claim 16 wherein, in use, the users are progressing along a predetermined path having a start, an end, and at least one waypoint between the start and the end, and the first database contains location data for the waypoints.

24. A system according to claim 23 wherein the processor is also selectively responsive to the location data for the waypoints when generating the first signal.

25. A system according to claim 16 including an interface for allowing external devices to selectively access the location data or event data derived from the location data.

26. A system according to claim 16 wherein each wearable device includes a single housing for the receiver, the processor and the interface.

27. A system according to claim 26 wherein each wearable device includes a fastening system for allowing releasable fastening of the housing to the respective users.

28. A system according to claim 17 wherein the indication of the respective positions of the users relative to one or more of the other users occurs continuously as the users are progressing along the predetermined path.

29. A system according to claim 17 wherein the indication of the respective positions of the users relative to one or more of the other users occurs intermittently as the users are progressing along the predetermined path.

30. A system according to claim 17 wherein the indication of the respective positions of the users relative to one or more of the other users occurs at a plurality of predetermined points spaced apart along the path between the start and the end.

31. A method for providing to a plurality of users in a group of users with an indication of respective positions of the users relative to one or more of the other users in the group, the method including the steps of:
containing location data for the users in a first database;
providing a processing station for accessing the first database and being responsive selectively to the location data for generating first signals; and
providing a plurality of wearable devices for wearing by the respective users in the group, the wearable devices each including:
(a) a receiver for receiving the first signal;
(b) a processor for processing the first signal to generate a second signal; and
(c) an interface that is responsive to the second signal for visually displaying to the respective user the indication of the position of the user relative to one or more of the other users in the group.

32. A method according to claim 31 wherein the users are simultaneously progressing along a predetermined path having a start and an end and the indication of the respective positions of the users relative to one or more of the other users in the group is a substantially real time indication of one or more of:
a ranking of the respective users relative to one or more of the other users in terms of progress along the path;
an indication of the time interval along the path between the respective users and one or more of the other users;
an indication of the distance along the path between the respective users and one or more of the other users;
an indication of the distance between the respective users and one or more of the start and the end;
an indication of the respective time of arrival of the users at the end;
a rate of progress of the respective users relative to the rate of progress of any one or more of the other users; and
a required rate of progress of the respective users relative to the rate of progress of any one or more of the other users.
